(19) United States
(12) Patent Application Publication
(10) Pub. No.: US 2018/0089934 A1
(43) Pub. Date: Mar. 29, 2018

(54) Gaming Machine

(71) Applicants: Universal Entertainment Corporation, Tokyo (JP); Aruze Gaming (Hong Kong) Limited, Hung Hom (HK)

(72) Inventors: Kenji ENOKIDO, Tokyo (JP); Hiroki NAKAMURA, Tokyo (JP); Ken YOSHIKAWA, Tokyo (JP); Yukihiro KAWAKAMI, Tokyo (JP)

(21) Appl. No.: 15/494,394

(22) Filed: Apr. 21, 2017

Related U.S. Application Data
(60) Provisional application No. 62/399,704, filed on Sep. 26, 2016.

(51) Int. Cl. G07F 17/32; G07F 17/34

(52) U.S. Cl. CPC G07F 17/3213; G07F 17/34; G07F 17/3258

(57) ABSTRACT

A display state in which the specific symbol is displayed in all the rows of any of N columns continuously from one side of a symbol matrix to another side, a prize of the rank corresponding to the columns with the specific symbols displayed on all the rows of the columns is awarded.

### CROSS REFERENCE TO RELATED APPLICATION

The present application claims priority from U.S. Provisional Patent Application No. 62/399,704, which was filed on Sep. 26, 2016, the disclosure of which is herein incorporated by reference in its entirety.

### FIELD OF THE INVENTION

The present invention relates to a gaming device that enable winning of a plurality of ranks of progressive bonuses, apart from a game individually played in each of a plurality of gaming machines. Typically, such a gaming scheme is referred to as link progressive.

### BACKGROUND OF THE INVENTION

In a traditional link progressive, an amount of bet in each slot machine is partially accumulated in each unit game as a resource for multiple levels of progressive bonuses (e.g., 4 levels of Grand, Major, Minor, Mini), any of which is awarded to any of the slot machines connected to the controller which executes the progressive bonus, by a specific trigger occurring as a result of random determination.

By the specific trigger it means as follows. Namely, for example, when a player enters a gaming value such as coins and bills into an insertion slot of the slot machine, and press a spin button, a plurality of symbols are scrolled on a display provided at the front of a cabinet and automatically stopped.

If the symbols rearranged on the display result in a predetermined display state, i.e., when a result of winning a progressive bonus of the link progressive is displayed, any of the multiple levels of the progressive bonus is awarded. The predetermined display state is for example a predetermined number or more of specific symbols related to the trigger of the progressive bonuses are displayed on the display.

Further, a free game may be run a plurality of number of times when the progressive bonus occurs, in the process of determining which one of the multiple levels of progressive bonuses is to be awarded.

The prior art for such a link progressive is described in, for example, publications of US2007/0202944 (Oomori), US2008/0207298 (Marks et al), and US2010/0120509 (Oomori).

### SUMMARY OF THE INVENTION

As hereinabove described, the progressive bonus has a plurality of ranks, and the prizes obtainable are different. The benefit largely differ between the maximum prize and that obtained from the minimum. Thus, when there is an effect displayed to show a progressive bonus is won, the player will be interested in which rank of bonus (e.g., any one of four ranks of Grand, Major, Minor, Mini) he/she has won.

For the ranks of the progressive bonus, there are a mode of random determination in which the rank is determined by a random determination performed at the same time as the random determination of symbols to be rearranged (mode of random determination to determine at once); and a mode of random determination separately performed after the display state triggering the progressive bonus occurs (progressive bonus rank random determination).

However, in cases of the determining the progressive bonus rank at the same time of randomly determining the above symbols (the mode of random determination at once), usually, a separate random determination is separately performed, and after winning of a progressive bonus is indicated, and then the rank of the progressive bonus rank won is indicated through a progressive bonus rank determination effect. As described, traditional gaming machines often do not immediately indicate the rank of the rank of the progressive bonus won, even if the rank is determined beforehand, and perform a progressive bonus rank determination effect. This is because the player's attention to the rank is increased in many cases. Therefore, to let players to continuously think which one of the rank he/she has won, the progressive bonus rank determination effect is adopted to further enhance the player's expectation. The progressive bonus rank determination effect performed before indication of the rank having been won therefore is a part of a very important performance of the gaming machine.

There are various progressive bonus rank determination effects described above. Examples of such an effect includes: a player-participation type which involves player's input through a touch panel to let the player feel he/she contributed to determination of the rank; and a player-non-participation type which displays a video that leads to a winning for each rank, followed by indication of the rank which has been determined. Any rank determination effect, however, is at all different from the nature of a game of a slot machine, that is, to shuffle and rearrange symbols.

Further, the player-participation type which runs a game different from that of the slot machine necessitates a memory volume for storing data to run such a game, and the player-non-participation type also requires a memory volume, as in the player-participation type, for storing multiple sets of video data.

In view of the above problem, an object of the present invention is to provide a new effect control for a slot machine, which allows a progressive bonus rank determination effect, for the rank randomly determined in advance, close to the nature of the game of a slot machine.

(Invention 1)

An aspect of the present invention is a gaming machine, comprising: a display configured to display a symbol matrix of M rows and N columns;
a game controller configured to run a slot game using the symbol matrix;
a storage device storing various sets of symbol data, for displaying the slot game on the display; and
a graphic controller configured to extract the various sets of symbol data from the storage device, and generate display data, for a purpose of displaying on the display a set of display content determined by the game controller,
wherein the game controller executes a rank determination game with respect to the graphic controller, when the game controller receives the rank of a prize randomly determined in advance by a second controller, leading to occurrence of a display effect trigger for indicating the rank of the prize, said rank determination game including:
(A) a stage of displaying an indication of the rank of prize by associating it with one or more columns;
(B) a stage of displaying scroll of symbols in all of the N columns to rearrange the symbols;
(C) a stage in which, if one or more specific symbols are displayed in the symbol matrix as the result of the rearrangement, a subsequent symbol scroll is executed while maintaining the one or more specific symbols displayed;
(D) a stage of executing the steps of (B) and (C) a predetermined number of times;
(E) a stage of, when repeating of the series of stages the predetermined number of times results in a display state in which the specific symbol is displayed in all the rows of any of the N columns continuously from one side of the symbol matrix to the other side, awarding the prize of the rank corresponding to the columns with the specific symbols displayed on all the rows of the columns.

With the above-described structure, the rank of a prize determined in advance is indicated by a display state similar to display state repeating rearrangement of the symbols which is the concept of the slot game.

(Invention 2)

The controller is configured so that in the stage of (A), the ranks of the prizes associated to columns of the symbol matrix arranged side by side from the one side to the other side are indicated in such a manner that the rank of prize is increased towards the other side; and
in the stage of (E), a prize of the rank associated to a column at the end on the other side, out of successive columns of the symbol matrix arranged side by side from the one side to the other side with the specific symbols in all the rows, is awarded.

In the process of repeating symbol rearrangement a predetermined number of times in the above structure, the specific symbol arranged in a play of game is fixed and kept being displayed in the following play of the game. This provides a player-visible sequential effect in which the specific symbol is additionally fix-displayed in the symbol matrix at each end of a play of the game. The more columns each with the specific symbol filled in all rows continues from the one side to the other side of the symbol matrix in the effect, the higher rank of the prize is awarded to the player. That is, the player is awarded the prize of the rank associated to a column before continuation of columns with the specific symbols in all rows becomes non-continuous.

(Invention 3)

the stage of (E) further includes a stage of awarding a fixed payout which is set in advance, if the endmost column on the one side has the specific symbol in all its rows and there is no column with the specific symbol arranged in every row on the other side.

With the above-described structure, the fixed payout is awarded if an endmost column on the one side has the specific symbol in all its rows and there is no column with the specific symbol arranged in every row on the other side. Therefore, the player is provided with a case where no rank is won even if the rank determination game is started. For example, when the game for determining the progressive bonus rank is started, the player expects a prize of a rank which awards a high payout. However, there is a case where no rank of prize is won and no progressive bonus is obtained. In such a case however a fixed payout is awarded, although the progressive bonus of any rank is awarded.

(Invention 4)

A slot machine of the present invention, comprises:
a display on which control for rearranging symbols from the state of symbols stopped on each reel is executed a predetermined number of times to determine a rank out of a plurality of ranks of prizes;
a graphic controller, wherein each reel is associated with any of the plurality of ranks of the prizes, and the graphic controller is configured to display the label of the prize nearby the reels; and
a game controller, wherein, after the rearrangement of symbols, the symbols are brought into a hold state in a following rank determination game and if the symbol in the hold state occurs in all the symbol display areas of the reel, the game controller awards a prize of the rank stored in advance in association with the reel.

### BRIEF DESCRIPTION OF THE DRAWINGS

Other and further objects, features and advantages of the invention will appear more fully from the following description taken in connection with the accompanying drawings in which:

FIG. 1A is an explanatory diagram showing a display state in which a feature symbol is rearranged in a symbol matrix of a gaming machine, which state does not trigger a bonus even with the rearrangement of the feature symbol.

FIG. 1B is an explanatory diagram showing a display state in which a feature symbol is rearranged in a symbol matrix of a gaming machine, which state does not trigger a bonus even with the rearrangement of the feature symbol.

FIG. 2 is an explanatory diagram showing an overall game flow of the gaming machine.

FIG. 3 shows a game system including a slot machine.

FIG. 4 is a perspective view of the slot machine in the gaming machine.

FIG. 5A is a diagram of an external appearance showing a plurality of gaming machines arranged in a single area.

FIG. 5B is a diagram of an external appearance showing a plurality of gaming machines arranged in two areas.

FIG. 6 is a diagram showing the display control functional flow of top boxes 121.

FIG. 7A is an explanatory diagram showing a display area virtually combining the display areas of the top boxes 121, and shows an image displayed in the display areas of the top boxes 121 of the slot machines 10.

FIG. 7B is an explanatory diagram showing an image displayed in the display areas of the top boxes 121 of the slot machines 10, and shows a predetermined period after the state of the FIG. 7A.

FIG. 7C is an explanatory diagram showing an image displayed in the display areas of the top boxes 121 of the slot machines 10, and shows how the image displayed in the display area of the top boxes shown in FIG. 7A is displayed on the individual top box 121.

FIG. 7D is an explanatory diagram showing an image displayed in the display areas of the top boxes 121 of the slot machines 10, and shows a predetermined period after the state of the FIG. 7C.

FIG. 8A is a diagram showing a transition of displays in the top box 121 and the upper image display panel 131, during a top box display control process in FIG. 7.

FIG. 8B is a diagram showing a transition of displays in the top box 121 and the upper image display panel 131, during a top box display control process in FIG. 7.

FIG. 8C is a diagram showing a transition of displays in the top box 121 and the upper image display panel 131, during a top box display control process in FIG. 7.

FIG. 8D is a diagram showing a transition of displays in the top box 121 and the upper image display panel 131, during a top box display control process in FIG. 7.

FIG. 8E is a diagram showing a transition of displays in the top box 121 and the upper image display panel 131, during a top box display control process in FIG. 7.

FIG. 9 is a diagram showing a structure of hardware of the slot machine 10.

FIG. 10A is an explanatory diagram showing a transition of the display state of the lower image display panel 141 in a stage in which the feature symbols 505 each of which is a type of specific symbol related to a bonus game entering condition are arranged in the symbol matrix to trigger a bonus in a base game G1, and shows a state in which feature symbols 505 are displayed in a symbol matrix in such a manner as to accomplish a display state that triggers a bonus.

FIG. 10B is an explanatory diagram showing a transition of the display state of the lower image display panel 141 in a stage in which the feature symbols 505 each of which is a type of specific symbol related to a bonus game entering condition are arranged in the symbol matrix to trigger a bonus in a base game G1, and shows a screen indicating a transition to a free game play count determination game which determines the number of the free game plays to be run, prior to start of the free game which is the bonus game.

FIG. 11A is a diagram showing a transition of the display state on the lower image display panel 141 which takes place in the free game play count determination game, and shows a status which occurs when the bonus game is triggered, in the control by the game controller 70 in which numbers are scrolled within a display area of each feature symbol 505 rearranged.

FIG. 11B is a diagram showing a transition of the display state on the lower image display panel 141 which takes place in the free game play count determination game, and shows a state in which the number of free game plays is indicated on the upper image display panel 131, the number of free game plays is a total of numbers displayed in the display areas of the feature symbols 505, after scrolling in the display areas of the feature symbols 505 are stopped.

FIG. 12 is a flowchart indicating a jackpot rank determination process.

FIG. 13A shows a process in the jackpot rank determination process. It shows a transition of the display state on the lower image display panel 141 which takes place from the base game G1 to occurrence of a trigger causing transition to a jackpot game G2. It is a diagram showing a state immediately before the display state where a JP coin symbol 504 triggers a jackpot game, the JP coin symbol being a jackpot symbol which is a type of specific symbols.

FIG. 13B shows a process in the jackpot rank determination process. It shows a transition of the display state on the lower image display panel 141 which takes place from the base game G1 to occurrence of a trigger causing transition to a jackpot game G2. It is a diagram showing a state of reaching the display state in which the jackpot game is triggered.

FIG. 14A is a diagram showing a screen transition from the display state of triggering the jackpot game, and shows a state in which the symbol matrix is temporarily masked.

FIG. 14B is a diagram showing a screen transition from the display state of triggering the jackpot game, and shows a state in which a symbol matrix for running a jackpot rank determination game appears through a gate-opening effect.

FIG. 15A shows a display state of the jackpot game run on the lower image display panel 141, and shows a rearrangement of the flower symbols 502 in a first play of the free game.

FIG. 15B shows a display state of the jackpot game run on the lower image display panel 141, and shows a rearrangement of the flower symbols 502 in a second play of the free game.

FIG. 16A shows a display state of the jackpot game run on the lower image display panel 141, and shows a rearrangement of the flower symbols 502 in a third play of the free game.

FIG. 16B shows a display state of the jackpot game run on the lower image display panel 141, and shows a rearrangement of the flower symbols 502 in a fourth play of the free game.

FIG. 17A shows a display state of the jackpot game run on the lower image display panel 141, and shows a rearrangement of the flower symbols 502 in an eighth play (final play) of the free game, and appearance of a character A on the upper image display panel 131.

FIG. 17B shows a display state of the jackpot game run on the lower image display panel 141, and shows a state in which the character A changes the arrangement of the flower symbols 502 rearranged in an eighth play of the free game.

FIG. 18 shows a display state of the jackpot game run on the lower image display panel 141, and shows an effect that shows the character A is involved in the arrangement of the flower symbols 502, after rearrangement of the flower symbols 502 in an eighth play of the free game.

FIG. 19A shows a display state on the lower image display panel 141 during the jackpot game, for determining which one of the GRAND, MAJOR, MINOR, MINI is to be won, and shows the display state of the MINI rank.

FIG. 19B shows a display state on the lower image display panel 141 during the jackpot game, for determining which one of the GRAND, MAJOR, MINOR, MINI is to be won, and shows the display state of the MINOR rank.

FIG. 19C shows a display state on the lower image display panel 141 during the jackpot game, for determining which one of the GRAND, MAJOR, MINOR, MINI is to be won, and shows the display state of the MAJOR rank.

FIG. 19D shows a display state on the lower image display panel 141 during the jackpot game, for determining which one of the GRAND, MAJOR, MINOR, MINI is to be won, and shows the display state of the JACKPOT WIN whereby a progressive bonus of the GRAND rank will be awarded.

### DETAILED DESCRIPTION OF THE PREFERRED EMBODIMENTS

As described hereinabove, the present invention has the following structure.

Namely, a game system includes: a plurality of gaming machines each having a first controller configured to run an individual game which is asynchronous among the game devices, and at least one display configured to display an image; and a second controller configured to run a common game which is synchronized among the gaming machines on the display of each gaming machine; wherein the second controller a display control unit configured to control display areas of the displays of the gaming machine as a display area of a single display; a game interruption processing unit which interrupts the asynchronous individual game run by each first controller simultaneously (interrupting the individual game even if the game is not yet finished), when a prize is determined as to be awarded to any of the gaming machine (e.g., when the second control determines that a gaming machine wins a progressive bonus); and wherein the display control unit is configured to move a character image displayed in said display area of the single display, after the game on the gaming machines are interrupted by the game interruption processing unit, the character image being for indicating the game machine to receive the prize, and stop the character image on the display of the gaming machine to receive the prize, after a predetermined period from the beginning of moving the character image.

An example of the above structure is further described with reference to the drawings.

(Overview of M×N Symbol Matrix)

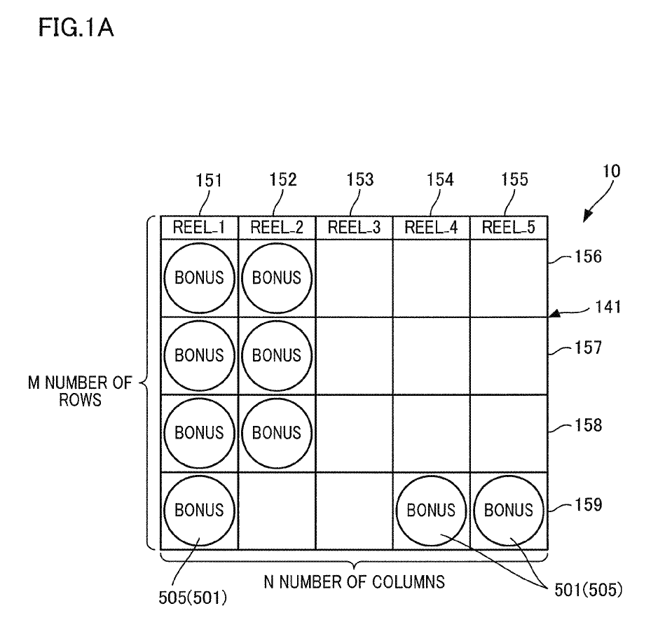

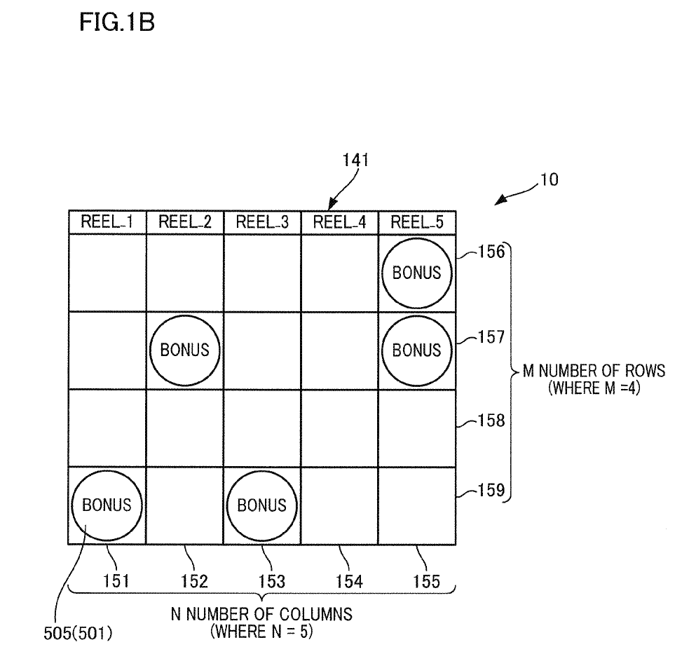

As shown in FIG. 1A and FIG. 1B, slot machines 10 as a gaming machines related to an embodiment of the present invention each has a plurality of reels 151 to 155, each configured to display a plurality of kinds of symbols 501 which are images, arranged side by side and rearranges the symbols 501 by scrolling and then stopping the reels 151 to 155. In the present example, the five reels have four lines so that M=4 and N=5, which form a symbol matrix of symbol arrangeable areas in four rows and five columns. This symbol matrix is displayed in the form of an image on the lower display panel 141 which is a display. The display is preferably a flat display such as a liquid crystal display, a plasma display, and an EL display.

Each slot machine 10 has the reels 151 to 155 arranged side by side, and includes a lower image display panel 141 (display device) configured to display a plurality of types of symbols 501 arranged on the reels 151 to 155; a game controller 70 (motherboard) corresponding to the first controller of the present invention, configured to rearrange the symbols 501 by scrolling and then stopping the reels 151 to 155. The game controller 70 is capable of running a slot machine game on the slot machines 10. The slot machine game is run independently of the other slot machines 10, and is not synchronized with the other slot machines 10. The structure of hardware including the game controller 70 is described later.

It should be noted that there are five reels 151 to 155 arranged side by side on the lower image display panel 141 in the present embodiment, however, the number of the reels is not limited to this, and may be any given number as long as the number is more than one.

Each symbol 501 illustrated as BOUNUS in FIG. 1A and FIG. 1B is a symbol related to a bounus game entering condition, which functions as a feature symbol 505. According to the rearrangement of the feature symbols 505, a bonus game is triggered.

More specifically, FIG. 1A shows a state in which the bonus is not triggered even with the feature symbols 505 rearranged in the symbol matrix, whereas FIG. 1B shows a state in which the bonus is triggered. Such a difference in the display states is determined by the controller for triggering the bonus.

Although the bonus triggering condition is not limited to the above, the present example deals with the game controller 70 performs a control so that a bonus is triggered when the feature symbol 505 occurs on all the reel1 (first column) 151, reel2 (second column) 152, and reel3 (third column) 153 (i.e., on all three columns).

More specifically, in a case shown in FIG. 1A, the feature symbol 505 is rearranged in every row of the reel1 (first column) 151. Meanwhile, the feature symbol 505 is rearranged in the first row 156, the second row 157, and in the third row 158 of the reel2 (second column) 152. Further, no feature symbol 505 is rearranged on the reel3 (third column) 153. Further, the feature symbol 505 is rearranged in the fourth row 159 of the reel4 (fourth column) 154, and in the fourth row 159 of the reel5 (fifth column) 155. In this case, since the reel3 (third column) 153 nas no feature symbol 505 rearranged, the game controller 70, as the role of detection unit for a bonus trigger, determines that the display state is one that does not trigger a bonus, and hence does not trigger a bonus. This is because, not every one of the first column 151 to the third column 153 has the feature symbol 505 rearranged thereon.

Next, FIG. 1B shows a display state that triggers a bonus. As shown in FIG. 1B, the feature symbol 505 is rearranged in the fourth row 159 of the reel1 (first column) 151. Meanwhile, the feature symbol 505 is rearranged in the second row 157 of the reel2 (second column) 152. Further, the feature symbol 505 is rearranged in the fourth row 159 of the reel3 (third column) 153. No feature symbol 505 is rearranged on the reel4 (fourth column) 154. Further, the feature symbol 505 is rearranged in the first row 156 and the third row 158 of the reel5 (fifth column) 155. In this case, since a series of three columns, i.e., the reel1 (first column) 151, the reel2 (second column) 152, and the reel3 (third column) 153, all have a feature symbol 505 rearranged therein. Therefore, the game controller 70, as the role of detection unit for a bonus trigger, determines that the display state is one that triggers a bonus, and hence triggers a bonus. This is because, every one of the first column 151 to the third column 153 has the feature symbol 505 rearranged thereon.

(Outline of Gaming Machine: Definitions)

The above described slot machines is a type of gaming machine. While the present embodiment deals with a case where the slot machine 10 is an example of the gaming machine, the gaming machine is not limited to this, and may be any gaming machine provided that it runs a slot game in which a plurality of types of symbols 501 are rearranged, connected to another gaming machine via a communication line, as hereinafter described, connected to a controller (second controller of the present invention) separate from the controller of that gaming machine, and is a gaming machine used in a game system configured to run a common game which is synchronized amongst all the gaming machines connected via the communication line.

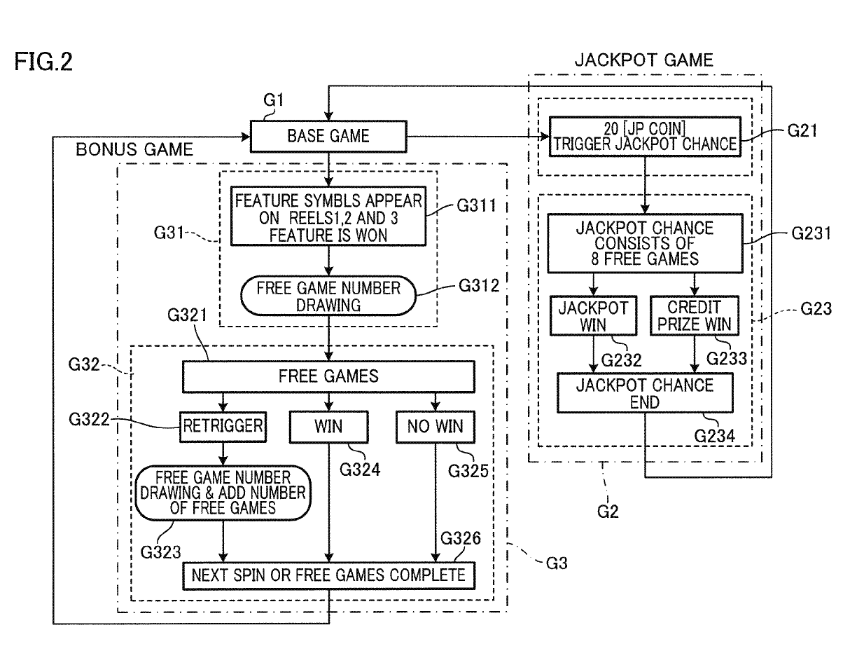

The slot machine 10 serving as the gaming machine of the present embodiment and in a broader scope serving as a game device is adapted so that the game controller 70 and an external controller 621 for controlling the later-described jackpot game control three kinds of games, i.e., a base game, a bonus game, and a jackpot game, as shown in FIG. 2.

(Base Game)

The base game G1 of the present embodiment is run by the game controller 70 (motherboard) of the slot machine 10. The base game is a slot game where a plurality of symbols 501 are rearranged. It should be noted that the base game is not limited to a slot game, and may be any game runnable in gaming machine such as slot machines 10 independently of and in an asynchronous manner with one another. In other words, the base game is a game in contrast to a jackpot game G2 which is a common game. For example, a normal game described later is a type of the base game.

The rearrangement of the symbols 501 in the slot game is conducted on the lower image display panel 141. The slot game includes: a process of running the normal game in which symbols 501 are rearranged on a lower image display panel 141 and a normal payout according to the symbols 501 rearranged is awarded, on condition that a bet of a gaming value is placed; and a process of making a transition to a bonus game G3 as the second game, when the symbols 501 rearranged in the normal game meet a predetermined condition, i.e., when a trigger condition is met.

Symbols 501 are constituted by a specific symbol and a normal symbol. In other words, the wording “symbol(s) 501” is a superordinate concept to the specific symbol and the normal symbol. The specific symbols include: a wild symbol 503, a feature symbol 505 serving as a trigger symbol (symbol related to a bonus game entering condition), a JP coin symbol 504 as a jackpot symbol related to a trigger for a jackpot game, and a flower symbol 502 used at a time of determining the rank of the jackpot prize of the jackpot game.

The wild symbol 503 is a symbol substitutable for any type of symbols 501. The feature symbol 505 serving as the trigger symbol is a symbol which triggers at least a bonus game. Description is omitted as to what display state of the feature symbols 505 in a symbol matrix including M rows and N columns (where M=4 and N=5) triggers a bonus, as it is already described with reference to FIG. 1.

The gaming value is electrically valuable information such as electronic money and the like. It is to be noted that the gaming value in the present invention is not limited to these, and for example a gaming medium such as a medal, a token, a coin, a ticket or the like can be adopted. A ticket is not particularly limited, and a later-mentioned barcoded ticket may be adopted, for example. Alternatively, the gaming value may be a game point not including valuable information.

(Bonus Game)

The bonus game G3 is started when the game controller 70 determines that the feature symbols 505 are displayed in the symbol matrix during the base game G1, in such a manner as to result in a predetermined display state that triggers a bonus.

The “bonus game G3” is described as a concept of the second game; however, the present invention is not limited to this, and the bonus game may be any type of game as long as it provides more advantageous gaming state than the normal game. In the present embodiment, the bonus game correspond to a set of a plurality of number of plays of a plurality of types of free games.

That is, the bonus game G2 of the present example include a stage of determining whether or not the bonus game is triggered and determining the number of plays of a free game run as the bonus game (G3-1), and a stage of running a free game the number of plays determined (G3-2).

After that follows a stage of repetitively running the free game so as to consume the number of plays of the free game determined (G321), until the number of plays of the free game determined in G31 is determined as to be consumed (G326). This sequence of stages are controlled by the game controller 70 as a single flow of the game.

This single flow of the game branches into three routes.

(I) a first branch flow including a stage of determining the number of plays of the free game, in which state a retrigger symbol is in a display state that causes an addition of a free game play (G322), and a stage of executing an effect display for addition of a number of free game plays (G323).
(II) a second branch flow including a stage of awarding a fixed payout corresponding to a WIN, when the WIN is displayed for a symbol matrix during a unit free game (G324).
(III) a third branch flow including a stage of ending a unit free game without any WIN and without a fixed payout, when no WIN is displayed for a symbol matrix during a unit free game (G325). Whether the flow branches into the above (I), (II), or (III), the game controller 70 runs the free game G321 until all the number of free game plays is consumed.

As hereinafter described, a characterizing feature of the present example of the invention are that the plurality of slot machines 10 are connected to a second controller 621 configured to cause a link progressive, via a communication line (encompassing a wireless network); and when a bonus game or a progressive bonus (also referred to as link progressive jackpot game) is triggered in any of the slot machines 10 (when a transition occurs from the base game to another game status which provides a possibility for winning a higher payout than that obtainable from the base game), an effect is provided using a plurality of displays 121 (hereinafter, top boxes 121) provided on the gaming machines, respectively, so that it seems as if every slot machine 10 has a chance of having the bonus game or the link progressive taking place therein.

In each the gaming machine, the game controller 70 stops running the base game during the effect, and if any slot machine 10 is in the middle of running a base game, that unit base game is interrupted. To enable resume of the game interrupted, interruption data which is data for resuming the game from the state where interruption took place is stored in, for example, RAM 73 which is a temporary storage rewritable by a game controller 70.

As should be seen from the above, when a prize is determined to be awarded to any of slot machines 10 connected to the external controller 621 (second controller) via a communication line 301, players of other slot machines 10 will be given a hope for winning the prize. This hope for the chance will be further sterengthened if a mystery bonus or a progressive jackpot is set to occur as the prize to be awarded to the slot machines 10.

The present embodiment includes the following invention.

Namely, a game system of the present invention includes: a plurality of slot machines 10 (gaming machine) each having a game controller 70 (first controller) configured to run an individual game which is asynchronous among the game devices, and at least one upper image display panel 131, a display areas of a top box 121, or a lower image display panel 141 (display) configured to display an image; and an external controller 621 (second controller) configured to run a common game which is synchronized among the slot machines 10 on the display of each game device.

The external controller 621 includes a display control unit 621A configured to control the displays of the plurality of slot machines 10 as a display area of a single display, and a game interruption processing unit 621B configured to simultaneously interrupt the asynchronous individual game run by game controllers 70 (interrupting the individual game without waiting for the end), when a prize is determined as to be awarded to any of the slot machines 10.

As a situation where a prize is determined as to be awarded to any of the slot machines 10, there is a case where the external controller 621 connected to the slot machines 10 adopts a progressive link, and the external controller 621 determines a progressive jackpot for any of the slot machines 10, or a bonus game is triggered in any of the game controllers 70.

In the latter case, it is the game controller 70 which triggers the bonus game. When the bonus game is triggered by the game controller 70, that game controller 70 transmits to the external controller 621 the triggering of the bonus game. The external controller 621 transmits a control signal to interrupt the game to the game controllers 70 of all the slot machines 10 via the game interruption processing unit 621C. Then, the display control unit 621A of the external controller 621 performs collective display control on the displays thereafter. When a unit game is interrupted before its ending in a slot machine 70, the interruption data is automatically generated by the game controller 70, and is temporarily stored in a memory. When the game is started (resumed), the game controller 70 refers to the data stored in the memory, for resuming the game. This is to avoid any disadvantage to the player whose game has been interrupted.

After the game interruption processing unit 621C executes interruption in the slot machines 10, the display control unit 621A moves a character image for indicating the gaming machine to be awarded of the prize in the display area of the single display, and stops the character image on the display of the gaming machine to be awarded the prize, after a predetermined period from the start of moving the character image. The display control unit 621A may be configured to directly control the displays of the slot machines 10, or may perform controls via the game controller 70 and the graphic board 130.

With the above-described structure, an occurrence of a prize in any of the plurality of the slot machines 10 triggers interruption of the asynchronous game run by the game controller 70 of each of the slot machine 10 connected to the external controller 621. To show which one of the slot machines 10 is entitled to the prize, a character image is displayed and moved in the displays handled as a single display area, and then stopped on the display of the slot machine 10 entitled to the prize (in the present embodiment, the upper image display panel 131 or the display area of the top box 121). For the predetermined period, the players of the gaming machines are each given a hope for winning the prize.

Regarding the predetermined period, a not-shown timer device may be connected to the external controller 621. By referring to this timer, the character image may be moved left and right to the display of all the gaming machines for a pre-set time (e.g., 5 seconds), and then stopped in a display of the gaming machine entitle to the prize.

Instead of adopting a timer device, it is possible to display a movie in which the character image stops at the winning slot machine 10 at the end, in the single display area constituted by the plurality of displays. The latter case however causes an increase in the data volume, to provide variations in the movie. Therefore, it is preferable to adopt a timer device and use a movie generating program which generates a movie data such that the character image stops at a predetermined slot machine 10 having won at a set timing, and display the movie thus generated. In other words, identification information of each slot machine 10 is stored in association with a set of effect movie related to the identification information, i.e., a set of movie data created in advance so that the character image stops at the display corresponding to the identification information. The display control unit 621A of the external controller 621 executes a control so that the movie data related to the identification information of the winning gaming machine is set and displayed.

It should be noted that in the present embodiment described later, the display control unit 621A of the external controller 621 is configured to always perform display control to the display area of the top box 121 of each slot machine 10. Meanwhile, the lower image display panel 141 on which symbols 501 are rearranged and the upper image display panel 131 are always controlled by the game controller 70. The upper image display panel 131 is controlled so that the character image A stopped in the display area of the top box 121 appears on the upper image display panel 131.

Further, the present invention encompasses the following embodiment.

The external controller 621 may be configured to execute a control that randomly determines a gaming machine for which the prize (so-called mystery prize) is to be awarded, even while the specific display state is not displayed on any display.

In the above structure, a prize may be awarded without occurrence of a special display state, even when the first game is suddenly interrupted. This more strongly enhances the player's hope that the prize may be awarded to the gaming machine he/she plays, while the character image moves on the display of each of the slot machines 10 set as a display area of the single display.

The “free game” is a game runnable with a bet of fewer gaming values than the normal game. Note that “bet of fewer amounts of gaming values” encompasses a bet of zero gaming value. The “free game” therefore may be a game runnable without a bet of a gaming value, which free game awards an amount of gaming values based on symbols 501 rearranged. In other words, the “free game” may be a game which is started without consumption of a gaming value. To the contrary, the “normal game” is a game runnable on condition that a gaming value is bet, which normal game awards an amount of gaming value based on the symbols 501 rearranged. In other words, the “normal game” is a game which starts with consumption of a gaming value.

The expression rearrange in this specification means dismissing an arrangement of symbols 501, and arranging symbols 501 once again. Arrangement means a state where the symbols 501 can be visually confirmed by a player. More specifically, “rearrangement” is a state in which, after the symbols 501 on the reels are variably displayed as the reels rotate, the variable display of the symbols 501 stops as the rotation of the reels stops, and the symbols 501 stop in the display window.

The following describes an external appearance, a hardware structure and the like of the slot machines 10 each serving as the gaming machine of the present invention and the game system including the slot machines 10, followed by description on control of an effect that provides players of all the slot machine 10 a hope that his/her slot machine 10 may have won a bonus or a link progressive, when the above mentioned link progressive or the bonus occurs.

(Overall Structure of Game System)

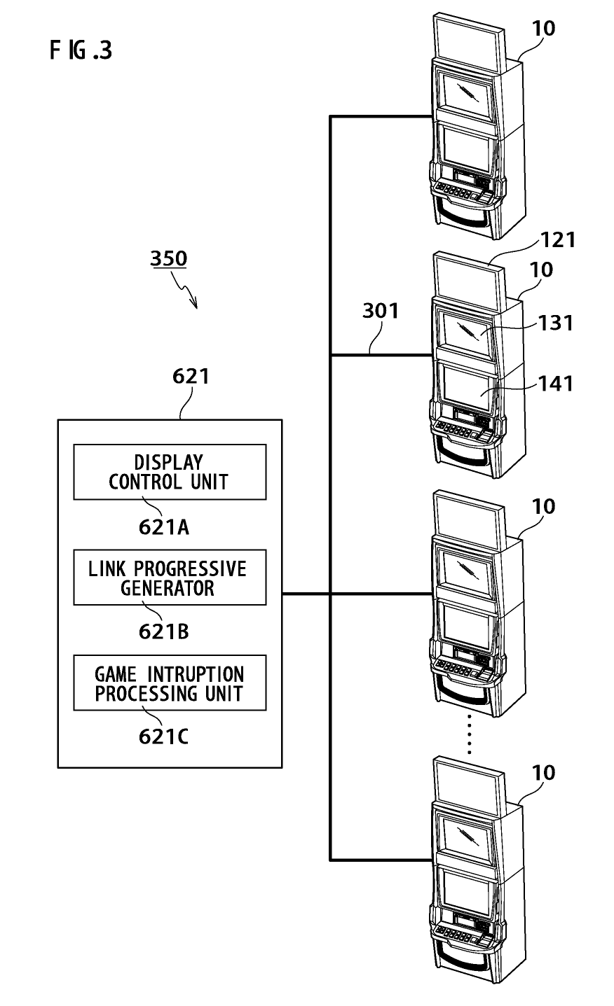

The following describes the game system including the slot machines 10, with reference to FIG. 3. FIG. 3 shows the game system including the slot machines 10 of the embodiment of the present invention.

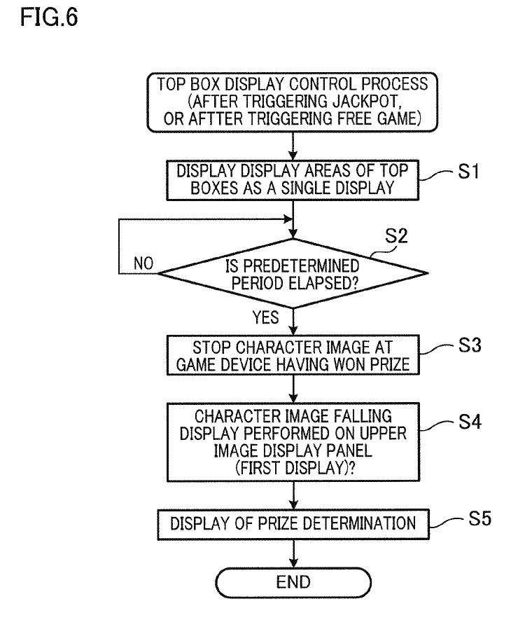

The external appearance of the game system 350 is such that four slot machines 10 are arranged on sides of a quadrangular shape in a plan view, as shown in FIG. 6, and there is provided the external controller 621 (second controller) connected to each slot machine 10 via a communication line 301.

The external controller 621 is configured to control the slot machines 10. In the present embodiment, the external controller 621 may also serve as a so-called hall server installed in a gaming facility where the plurality of slot machines 10 are provided. Each of the slot machines 10 has a unique identification number, and the external controller 621 identifies which one of the slot machines 10 transmitted data, by referring to the identification number. Further, the external controller 621 determines transmission target of data with the identification number when transmitting data to a slot machine 10.

Note that the game system 350 may be installed in one gaming facility where various games take place such as a casino, or between a plurality of game arcades. Further, when the game system 350 is constructed in a single gaming facility, the gaming system may be constructed in each floor or section of the gaming facility. The communication line 301 may be a wired or wireless line, and can adopt a dedicated line, an exchange line, or the like.

(Control of an effect that provides players of all the slot machine 10 a hope that his/her slot machine 10 may have won a bonus or a link progressive, when the above mentioned link progressive or the bonus occurs)

As shown in FIG. 3 and FIG. 6, the external controller (second controller) 621 includes the display control unit 621A that controls the display areas on top boxes 121 of the slot machines 10 as the display area of a single display.

When a prize such as the free game (bonus game) or the link progressive is determined as to be awarded to any of the slot machines 10, the external controller (second controller) 621 causes its game interruption processing unit 621C to transmit to the game controllers 70 a signal that forcedly interrupt the base game (individual game) asynchronously run in the slot machines 10 connected to the external controller 621.

The game interruption processing unit 621C interrupts the individual game running, without waiting for end of that individual game. Each game controller 70, upon reception of this signal for interruption, executes interruption of the game. Then, the display control unit 621A displays and moves a character image A that indicates which slot machine 10 will receive the prize, in the display area of the single display. The character image A is then stopped on the top box 121 of the slot machine to receive the prize, after a predetermined period from the beginning of moving the character image A.

In other words, the second controller 621 executes the following processes. In a top box display control process, display areas of the top boxes 121 are set as a single display area, when a display state, based on the feature symbols 505 as tye symbols related to the bonus game entering condition or flower symbols 502 used for determining the rank of the jackpot prize in a jackpot game, occurs on the lower image display panel 141 of a slot machine 10 (step S1).

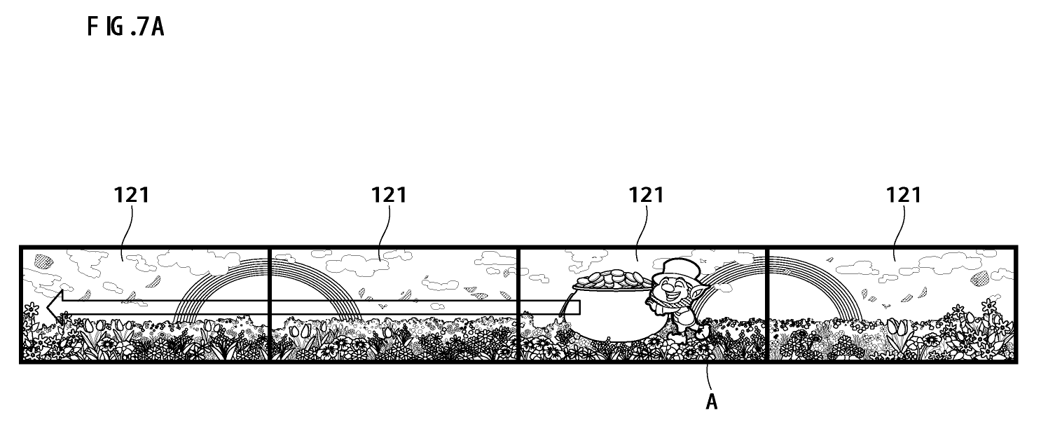

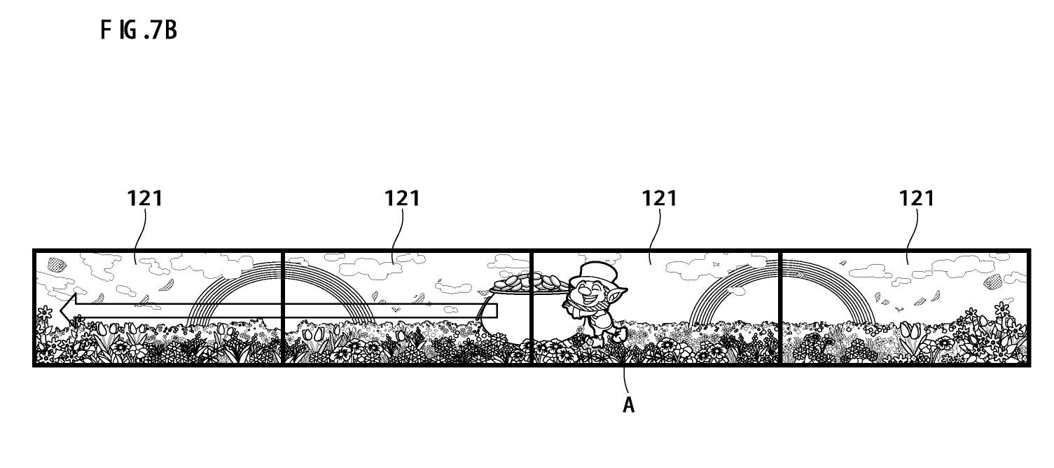

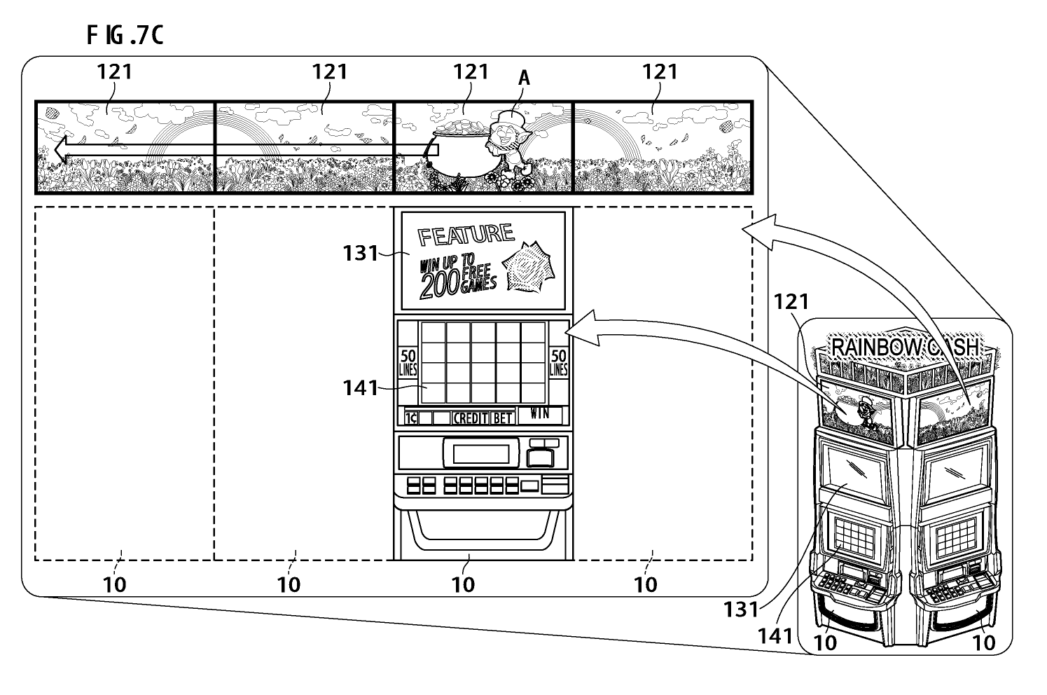

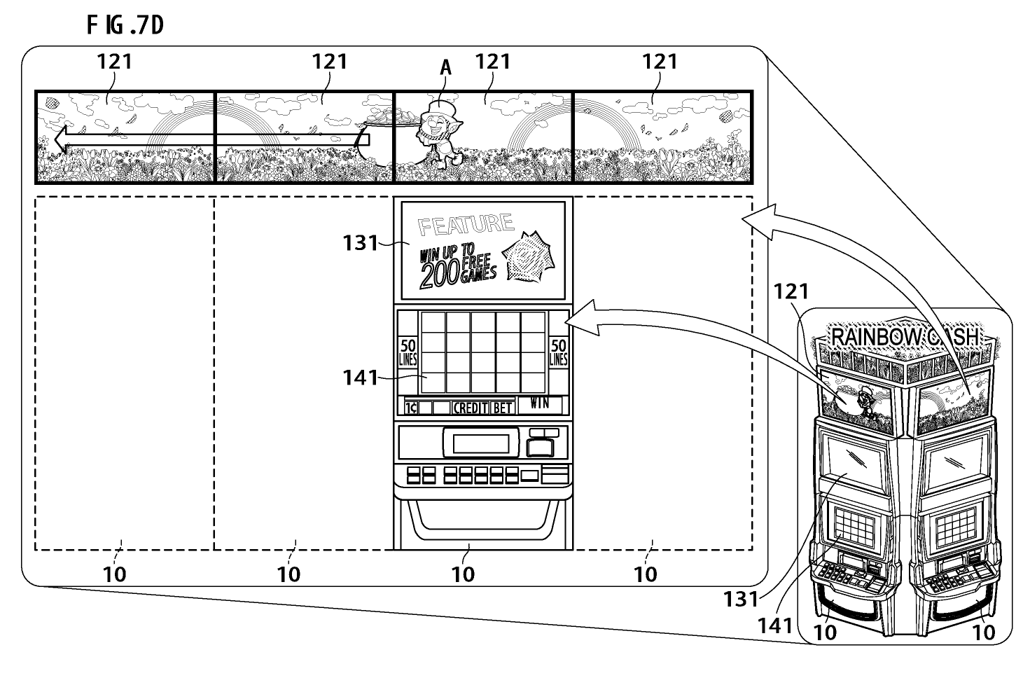

After this setting, the character image A moves from the right side to the left side as indicated by an arrow in FIG. 7A to FIG. 7B, on the top boxes 121 set as the single display area. FIG. 7A corresponds to the top boxes 121 of FIG. 7C, where as FIG. 7B corresponds to top boxes 121 of FIG. 7D.

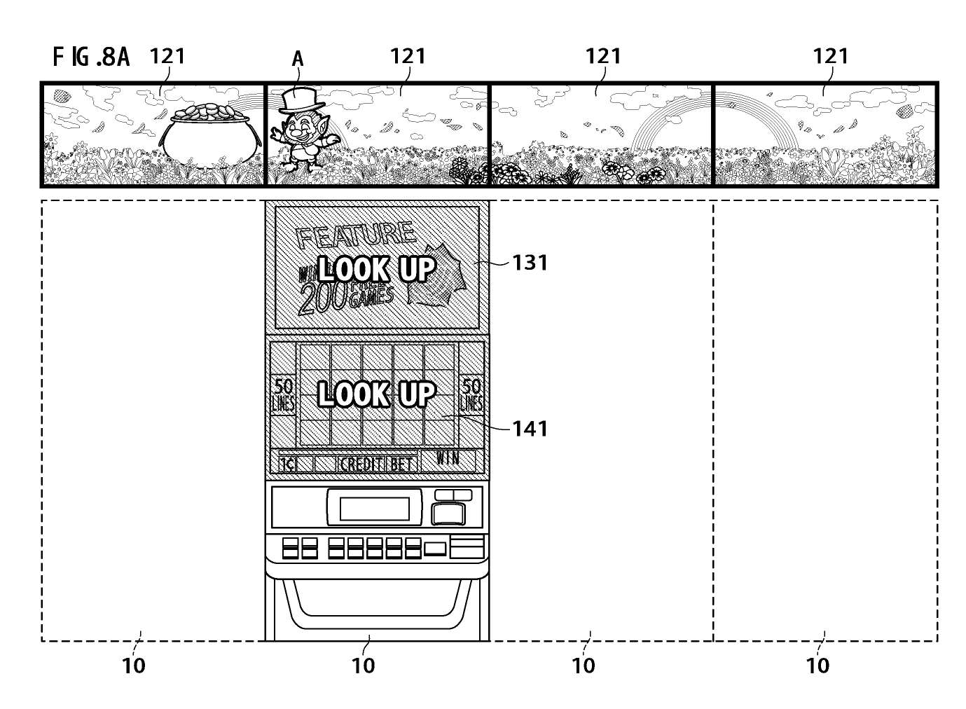

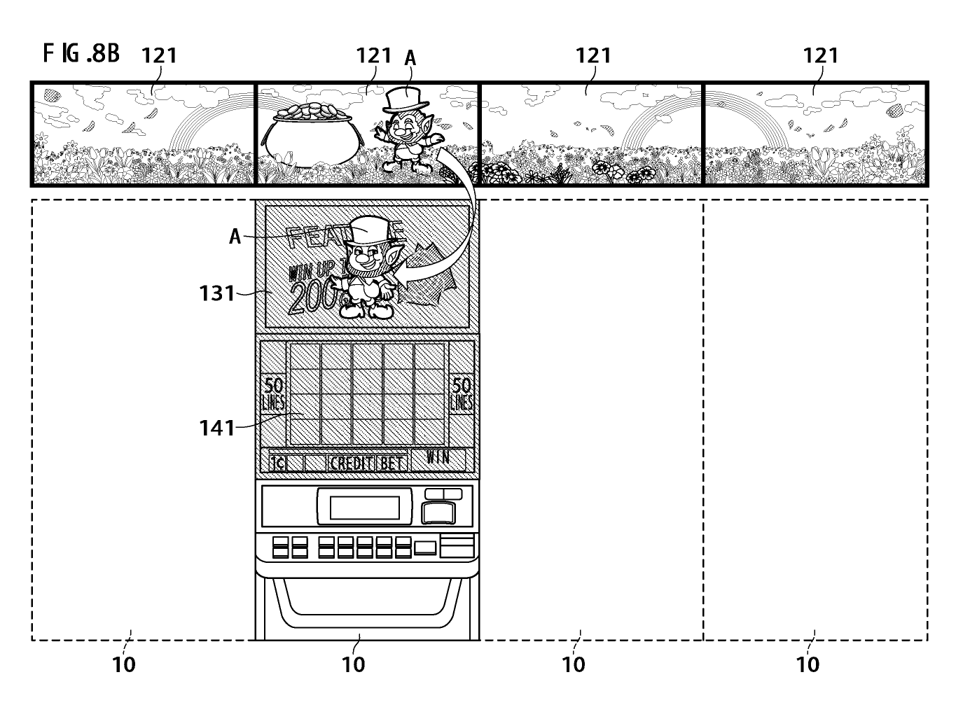

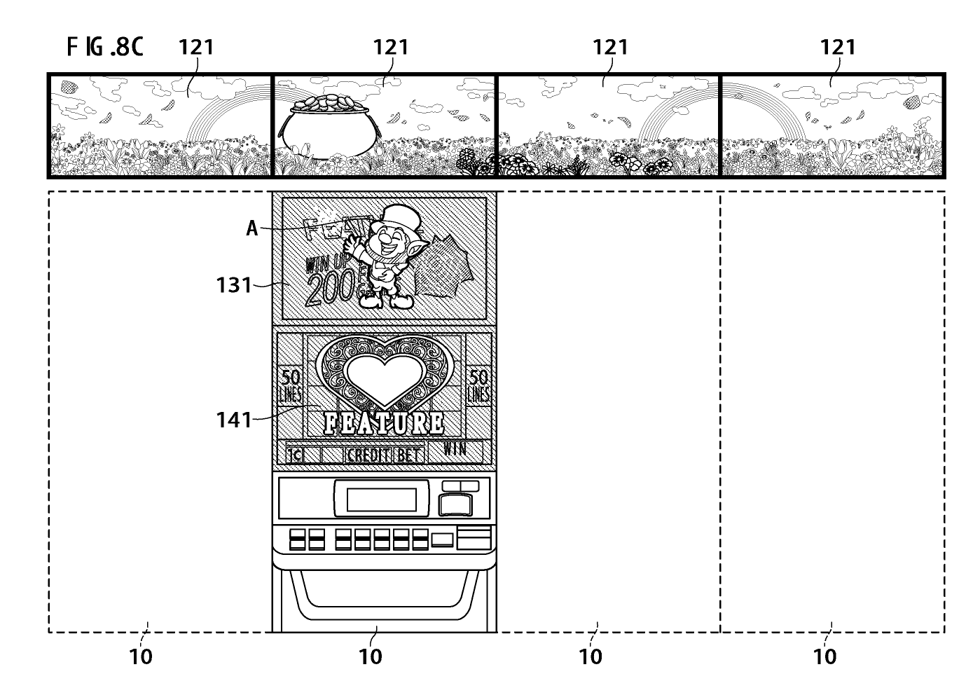

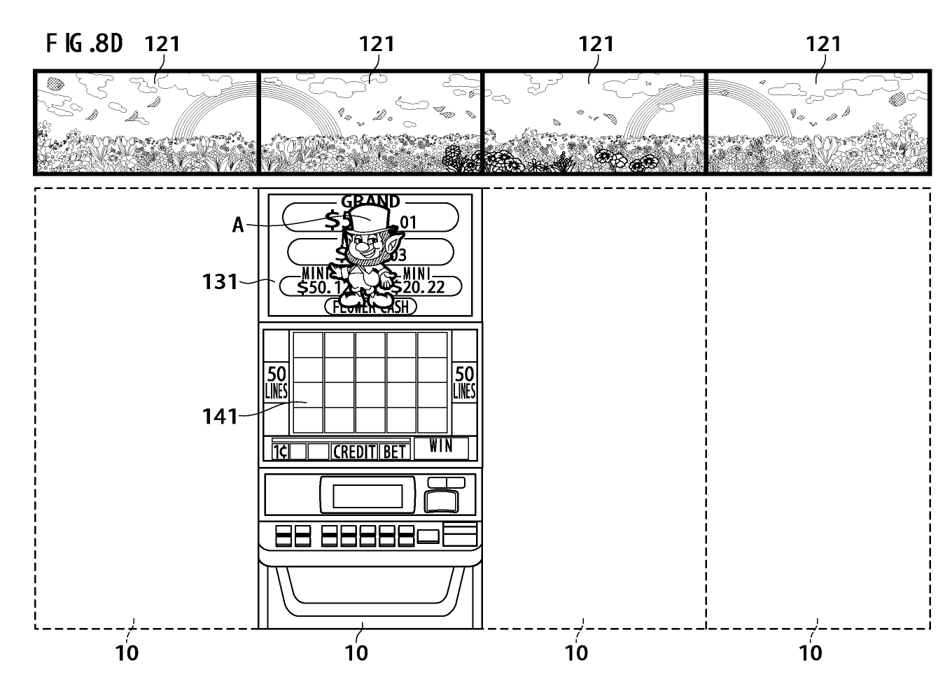

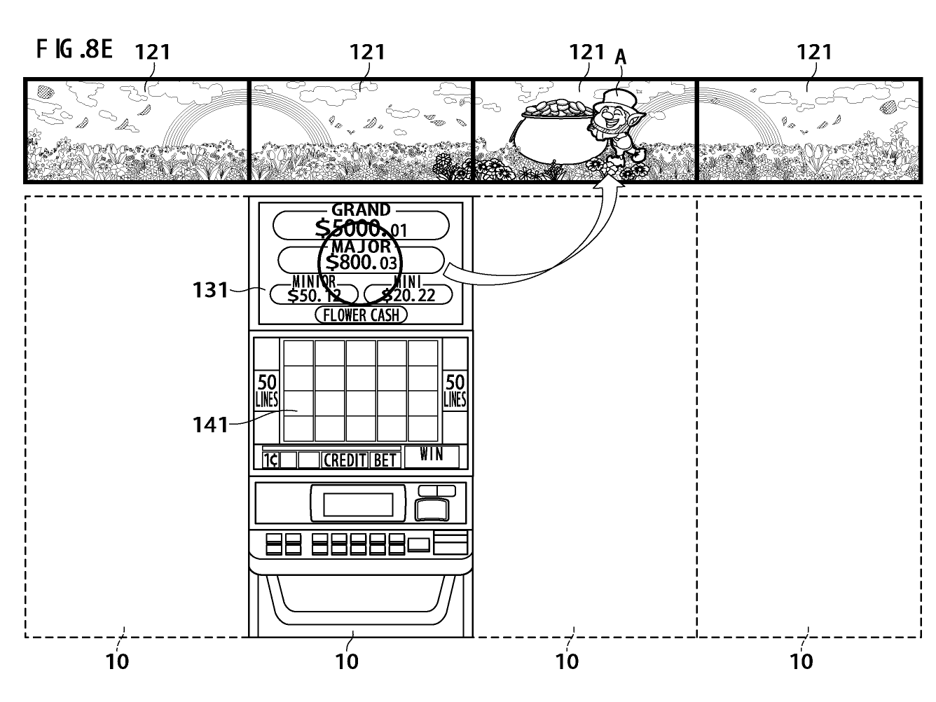

After the top boxes 121 are set as the single display area in step S1, the external controller 621 (second controller) displays a movie in which the character image A moves from the right to the left so as to make a transition of the image from FIG. 7A to FIG. 7B. Then, with reference to the not-shown timer (timing means) of the external controller 621, the character image A is moved for a pre-set period of time. When the predetermined period is determined as to be elapsed (step S2), the character image A is stopped in the top box 121 of the slot machine to receive the prize (step S3, FIG. 8B).

After the character image A is stopped in the top box 121 of the slot machine to receive the prize, the character image A is moved from the top box 121 to the upper image display panel 131 (step S4). This control is executed by the display control unit 621A of the external controller 621.

Then the display control unit 621A executes displaying of the prize being determined on the lower image display panel 141, while displaying the character image A on the upper image display panel 131 (step S5, FIG. 8C). Then, as shown in FIG. 8E, the displaying of the prize being determined is erased from the lower image display panel 141, and the symbol matrix is brought back to a visible state. Then, the character image A is moved from the upper image display panel 131 to the top box 121.

In the present invention, the rank of a prize determined in advance is indicated by a display state similar to display state repeating rearrangement of the symbols which is the concept of the slot game. Therefore, there is no need for ensuring data area for running another game in the memory card 54 serving as a storage device storing the game program, nor is it necessary to provide an exclusive input device for running the other game different from the slot game. To add this, since the concept of the game is the same as that of the slot game, it is advantageous for players as the content of the game is easy to understand.

Adoption of the same game concept as the slot game is also advantageous in that sharing data or design of the program is made simple.

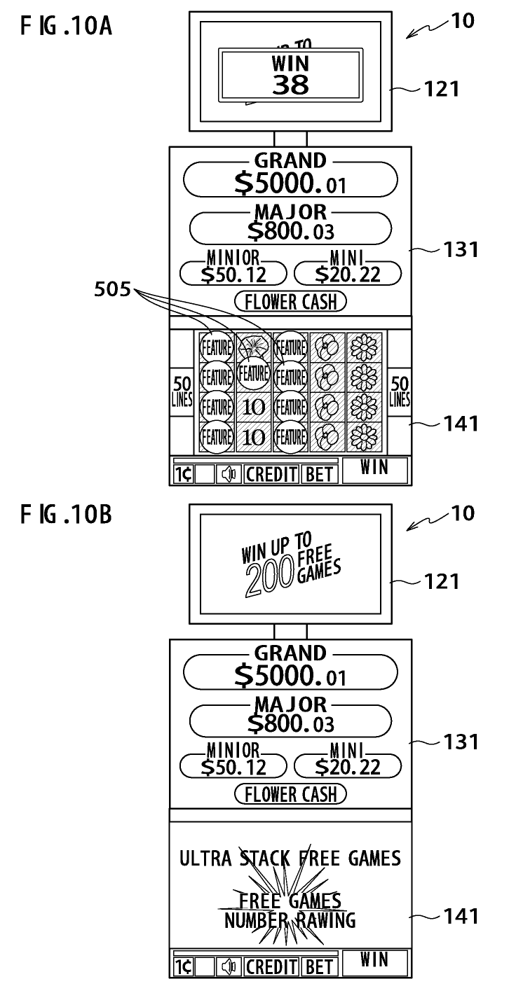

The flow of the top box display control process should be understood from the above. FIG. 10A and FIG. 10B show a transition of the display state of the lower image display panel in a stage in which the feature symbols 505 each of which is a type of specific symbol related to a bonus game entering condition are arranged in the symbol matrix to trigger a bonus in a base game G1. FIG. 10A is an explanatory diagram showing a display state in which the feature symbols 505 are arranged in the symbol matrix to trigger a bonus, and FIG. 10B shows a screen indicating a transition to a free game play count determination game which determines the number of the free game plays to be run, prior to start of the free game which is the bonus game.

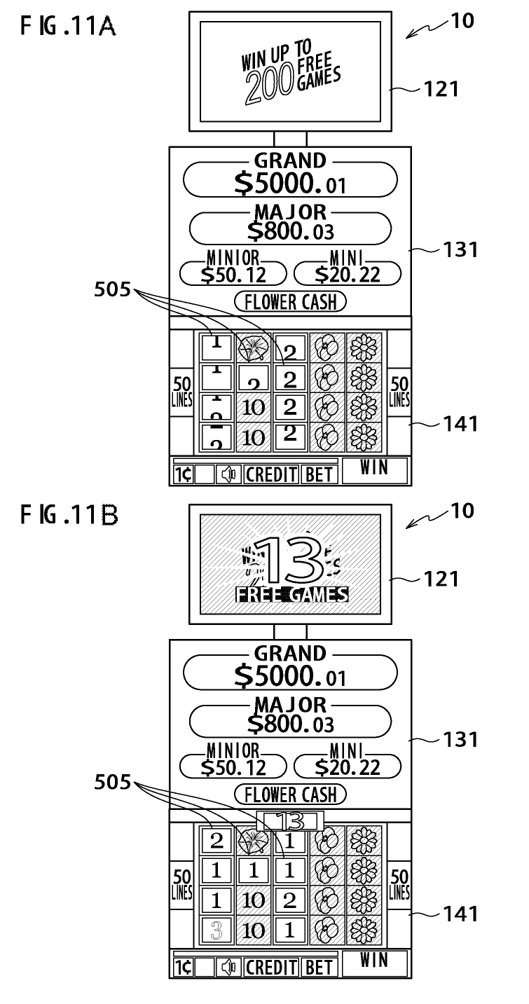

FIG. 11A and FIG. 11B are each a diagram showing transition of the display state on the lower image display panel 141 which takes place during a free game play count determination game. FIG. 11A shows a status which occurs when the bonus game is triggered, in the control by the game controller 70 in which numbers are scrolled within a display area of each feature symbol 505 rearranged. FIG. 11B shows a state in which the number of free game plays is indicated on the upper image display panel 131, the number of free game plays is a total of numbers displayed in the display areas of the feature symbols 505, after scrolling in the display areas of the feature symbols 505 are stopped.

As described, players are provided with a possibility that, when a bonus is triggered, the number of feature symbols 505 rearranged in the symbol matrix may affect whether the player will win a large number of free game plays, in the following free game play count determination game. The higher the number of feature symbols 505 rearranged in the symbol matrix at the time of triggering a bonus, the more hope the players may have for winning a large number of free game plays.

(Mechanical Structure of Slot Machine)

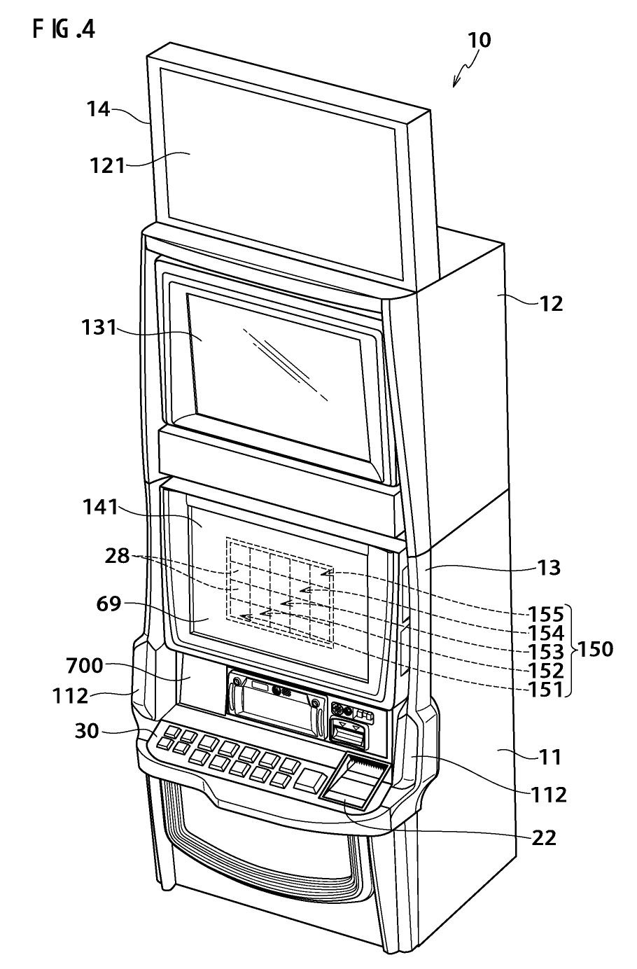

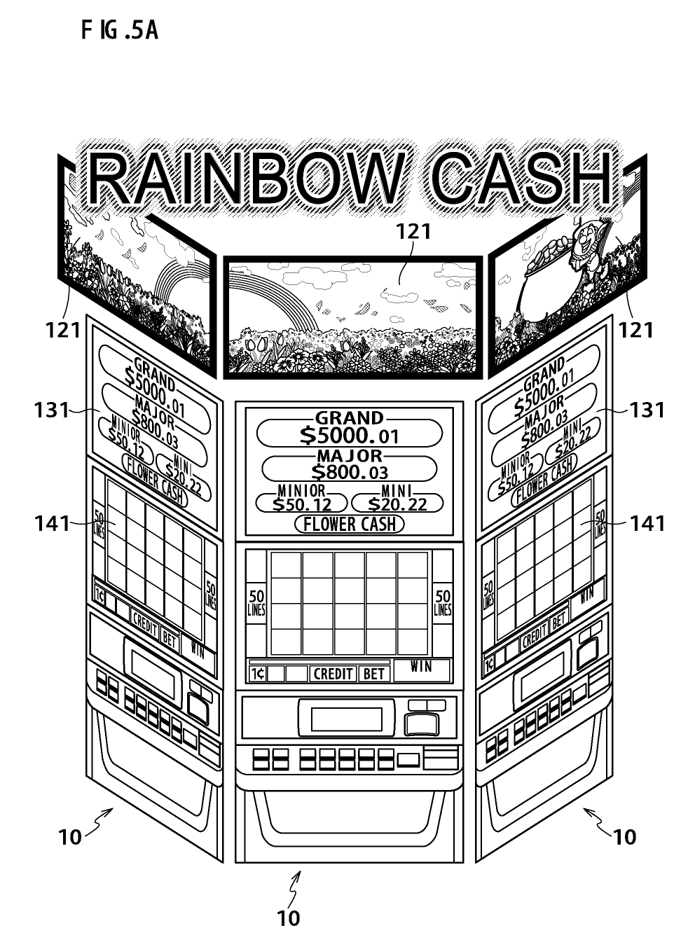

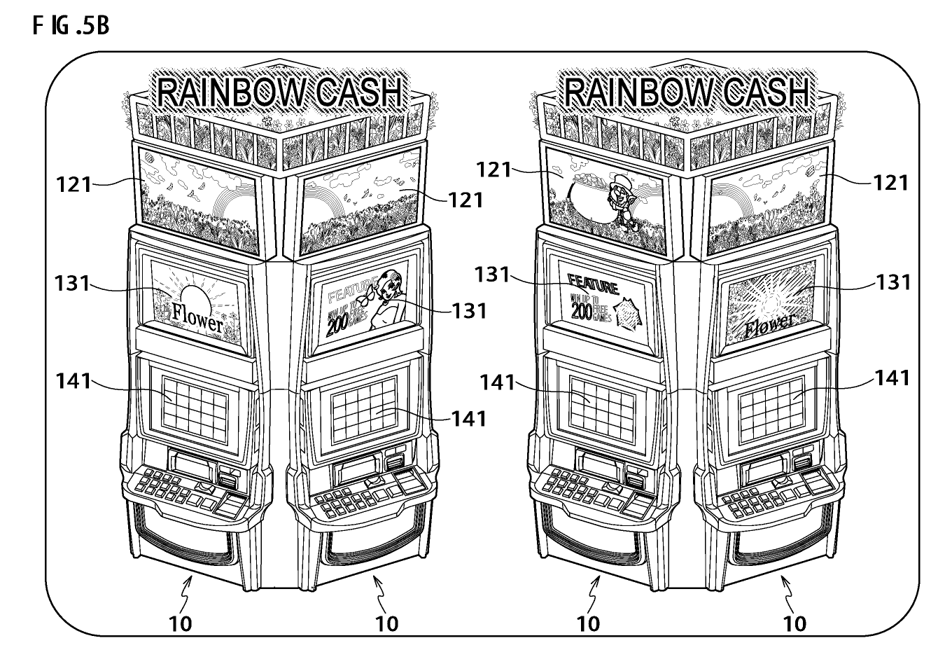

Now, referring to FIG. 4, the overall structure of the slot machine 10 will be described.

Electrically valuable information such as electronic money is used as a gaming value in the slot machine 10. It is to be noted that the gaming value is not limited to this, and for example a coin, a medal, a token, a ticket with a bar code and the like can be adopted.

The slot machine 10 includes a cabinet 11, a top box 12 installed on the upper side of the cabinet 11, and a main door 13 provided at the front surface of the cabinet 11. To the main door 13, there is provided a speaker 112.

On the main door 13, a symbol display device termed lower image display panel 141 is provided. The symbol display device is formed by a transparent liquid crystal panel. The screen displayed on the lower image display panel 141 has a symbol display area 150 at the central portion. The symbol display area 150 is constituted by 20 display blocks 28 forming a matrix of five columns and four rows. The four display blocks 28 of each column form simulated reels 151 to 155. On each of the simulated reels 151 to 155, four display blocks 28 move downward with changes in speed, so that the symbols 501 on the display blocks 28 are vertically rotated (variably displayed) and then stopped, in other words, the symbols are rearranged. The details of the display screen on the lower image display panel 141 will be given later.

While the present embodiment the slot machines 10 are so-called video slot machines, some mechanical reels in the slot machines 10 of the present invention may be replaced by the simulated reels 151 to 155. When mechanical reels are adopted, the a transparent display is preferably arranged in front of the mechanical reels, so that an image is displayed on the front surface of the reels.

On the front surface of the lower image display panel 141, a touch panel 69 is provided. The touch panel 69 allows a player to input various instructions by touching the display screen of the lower image display panel 141. The input signal is transmitted from the touch panel 69 to the main CPU 71.

An upper image display panel 131 is provided at the front surface of the top box 12. The upper image display panel 131 is structured by a liquid crystal panel, and forms the display. The upper image display panel 131 displays images related to effects and images showing introduction of the game contents and explanation of the game rules.

To the upper surface wall of the top box 12 is provided a topper device 14. The topper device 14 has a liquid crystal panel 121, and images and the like related to effects are output through the liquid crystal panel 121. The liquid crystal panel 121 of the topper device 14 is configured so that images displayed thereon is visible by a player distanced from the slot machine 10.

In the upper portion of the topper device 14 is provided a lamp 111. The slot machine 10 produces effects by displaying images, outputting sounds, and outputting light.

Below the lower image display panel 141, there are provided a control panel 30 having various buttons, a PTS device 700, and a bill entry 22.

The bill entry 22 validates bills and receives genuine bills into the cabinet 11. The bill entry 22 is electrically connected to the PTS device 700, and when a genuine bill is received, transmits to the PTS device 700 an input signal based on the value of the bill. The input signal includes information on credit data or the like related to the received bill.

The PTS device 700 is a unit in which an LCD (liquid crystal display), a human detection camera, a microphone, and the like are integrated. The human detection camera makes it possible to detect the presence of a player by the camera function. The microphone is used for the player's participation in a game by voice and the authentication of a player by voice recognition. Further, the PTS device 700 has a card insertion slot into which an IC card can be inserted. With this, the player is able to insert an IC card into the card insertion slot and use the credits stored in the IC card in the slot machine 10.

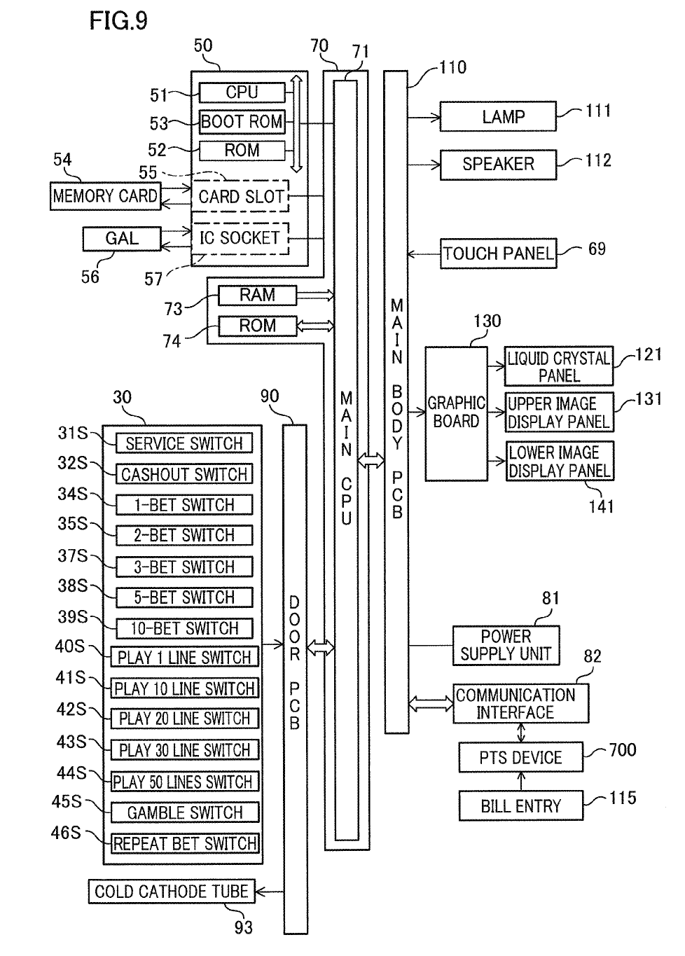

(Electrical Structure of Slot Machine) The following describes a circuitry structure of the slot machine 10, with reference to FIG. 9.

A gaming board 50 is provided with: a CPU 51, a ROM 52, and a boot ROM 53, which are mutually connected by an internal bus; a card slot 55 corresponding to a memory card 54; and an IC socket 57 corresponding to a GAL (Generic Array Logic) 56.

The memory card 54 includes a nonvolatile memory, and stores a game program. The game program includes a program related to game progression and an effect program for producing effects by images and sounds.

Further, the card slot 55 is configured so that the memory card 54 can be inserted thereinto and removed therefrom, and is connected to a motherboard 70 by an IDE bus. The type and contents of the game to be played on the slot machine 10 can be changed by drawing out the memory card 54 from the card slot 53S, writing another game program into the memory card 54, and inserting the memory card 54 into the card slot 53S.

The GAL 56 is a type of PLD (programmable logic device) having a fixed OR array structure. The GAL 56 is provided with a plurality of input ports and output ports, and predetermined input into the input port causes output of the corresponding data from the output port.

Further, the IC socket 57 is configured so that the GAL 56 can be inserted thereinto and removed therefrom, and is connected to the motherboard 70 by a PCI bus. The contents of the game to be played on the slot machine 10 can be changed by replacing the memory card 54 with another memory card 54 having another program written therein or by rewriting the program written into the memory card 54 as another program.

The CPU 51, the ROM 52, and the boot ROM 53 mutually connected by the internal bus are connected to the motherboard 70 by a PCI bus. The PCI bus enables a signal transmission between the motherboard 70 and the gaming board 50, and power supply from the motherboard 70 to the gaming board 50.

The ROM 52 stores an authentication program. The boot ROM 53 stores a preliminary authentication program, a program (boot code) to be used by the CPU 51 for activating the pre-authentication program, and the like. The authentication program is a program (falsification check program) for authenticating the game program. The pre-authentication program is a program for authenticating the aforementioned authentication program. The authentication program and the pre-authentication program are written along a procedure (authentication procedure) for proving that the program to be the subject has not been falsified.

The motherboard 70 is constituted by a motherboard for market use (printed circuit board with fundamental parts of a personal computer built thereon), and includes the main CPU 71, a ROM (Read Only Memory) 72, a RAM (Random Access Memory) 73, and a communication interface 82. This motherboard 70 corresponds to a game controller 100 of the present embodiment.

The ROM 72 includes a memory device such as a flash memory, and stores a program such as BIOS (Basic Input/Output System) to be executed by the main CPU 71, and permanent data. When the BIOS is executed by the main CPU 71, processing for initializing predetermined peripheral devices is conducted. Further, through the gaming board 50, a process of loading the game program stored in the memory card 54 is started. In the present invention, the ROM 72 may be rewritable or not rewritable.

The RAM 73 stores data used for the operation of the main CPU 71 (later-described various tables and the like) and programs such as a symbol determination program. For example, when the process of loading the aforementioned game program or authentication program is executed, the RAM 73 can store the program. The RAM 73 is provided with working areas used for operations when these programs are executed. Examples of the areas include: an area that stores a counter which manages the number of plays of games, the bet amount, the payout amount, the credit amount, and the like; and an area that stores symbols (code numbers) randomly determined.

The communication interface 82 is for communicating with the PTS device 700 and the external controller. The PTS device 700, upon reception of an input signal from the bill entry 22, transmits credit data contained in the input signal to the main CPU 71 via the communication interface 82. Further, when an IC card is inserted into the card insertion slot, the PTS device 700 transmits credit data stored in the IC card to the main CPU 71 via the communication interface 82. The PTS device 700 also writes credit data into the IC card inserted into the card insertion slot, based on a control signal received from the main CPU 71 via the communication interface 82.

Further, the motherboard 70 is connected with a later-described door PCB (Printed Circuit Board) 90 and a main body PCB 110 by respective USBs.

The motherboard 70 is also connected with a power supply unit 81. When the power is supplied from the power supply unit 81 to the motherboard 70, the main CPU 71 of the motherboard 70 is activated, and then power is supplied to the gaming board 50 through the PCI bus so as to activate the CPU 51.

The door PCB 90 and the main body PCB 110 are connected with input devices such as a switch and a sensor, and peripheral devices the operations of which are controlled by the main CPU 71. The door PCB 90 is connected with the control panel 30, and a cold cathode tube 93.

The control panel 30 is provided with a service switch 31S, a cash-out switch 32S, a 1 bet switch 34S, a 2 bet switch 35S, a 3 bet switch 37S, a 5 bet switch 38S, a 10 bet switch 39S, a play 1 line switch 40S, a play 10 line switch 41S, a play 20 line switch 42S, a play 30 line switch 43S, a play 50 line switch 44S, a gamble switch 45S, and a repeat bet switch 46S which correspond to the above-described buttons, respectively. Each of the switches outputs a signal to the main CPU 71 upon detection of press of the button corresponding thereto by the player.

The cold cathode tube 93 functions as a backlight installed on the rear face sides of the upper image display panel 131 and the lower image display panel 141, and lights up based on a control signal output from the main CPU 71.

The main body PCB 110 is connected with the lamp 111, the speaker 112, the touch panel 69, the bill entry 22, and a graphic board 130. The lamp 111 turns on based on a control signal outputted from the main CPU 71. The speaker 112 outputs BGM sound or the like in accordance with a control signal output from the main CPU 71.

The touch panel 69 detects a position on the lower image display panel 141 touched by a finger or the like of the player, and outputs a signal corresponding to the detected position to the main CPU 71.

The bill entry 22 authenticates the bills and receives genuine bills into the cabinet 11. The amount of credit corresponding to the bills received by the cabinet 11 is added to the player-owned credit.

The graphic board 130 controls image displaying for each of the upper image display panel 131, the lower image display panel 141, and the liquid crystal panel 121, based on control signals output from the main CPU 71. The graphic board 130 is provided with a VDP (Video Display Processor) generating image data, the video RAM storing the image data generated by the VDP, and the like. It is to be noted that the image data used in generation of image data by the VDP is included in the game program that has been read from the memory card 54 and stored into the RAM 73.

The graphic board 130 is provided with the VDP (Video Display Processor) generating image data based on the control signal output from the main CPU 71, a video RAM temporarily storing the image data generated by the VDP, and the like. It is to be noted that the image data used in generation of image data by the VDP is included in the game program that has been read from the memory card 54 and stored into the RAM 73.

(Transition from Base Game to Link Progressive Jackpot Game, and Progressive Bonus Rank Determination Process)

The following describes a transition from the base game G1 to the jackpot game G2, with reference to FIG. 2. There are a stage G21 in which JP coin symbol 504 is rearranged in every position of the symbol matrix on the upper image display panel 131 and a stage G23 of determining any of the GRAND, MAJOR, MINOR, and MINI based on display on the upper image display panel 131.

The stage G23 of determining which rank is to be won includes: a stage (G231) of running the free game, using a reel having only the flower symbols 502 for jackpot, for a predetermined number of plays of the free game (in this embodiment, eight times); a stage (G232) of awarding a payout when a jackpot is won according to the state of rearrangement; a stage (G233) of awarding a fixed payout when no rank of bonus is won even after the predetermined number of plays of the free game are played; and a stage of (G234) of consuming the predetermined number of plays of the free game to end the rank determination game, and returning to the base game G1.

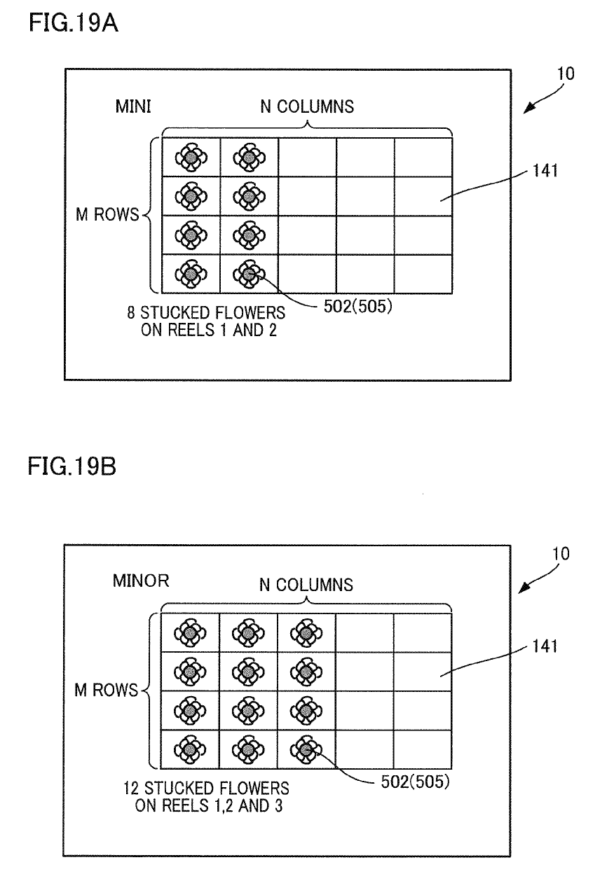

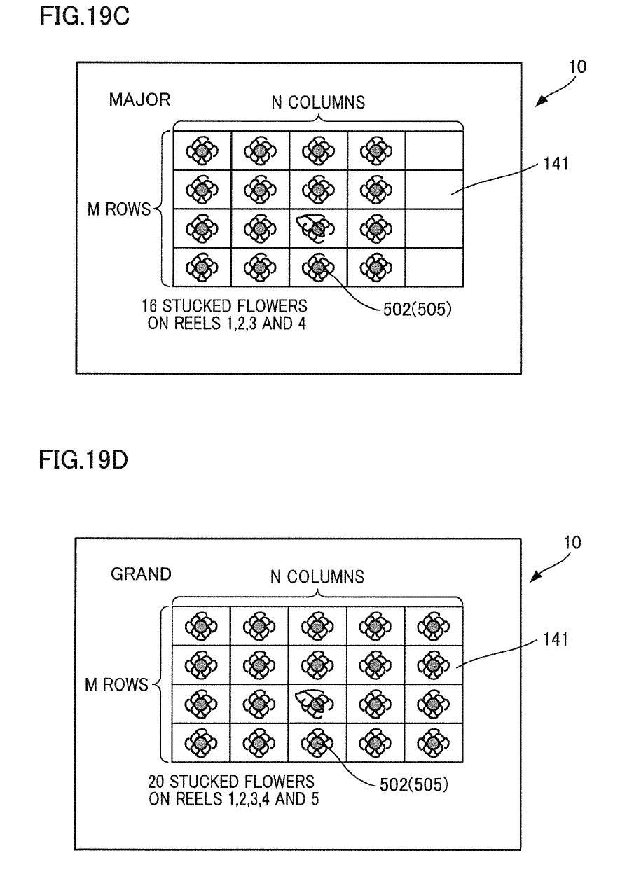

As shown in FIG. 19A to FIG. 19D, when the flower symbols 502 is arranged throughout the entire one or more columns to which GRAND, MAJOR, MINOR, or MINI is associated, the jackpot of the corresponding rank is won. Then, when multiple ranks of jackpots occurs, the higher rank of the jackpot is won.

That is, in the present invention, the following structure is adopted and the rank is determined based on the following structure.

Namely, the structure includes a plurality of lower image display panels 141 each of which displays a symbol matrix including M rows (M=4) and N (N=5) columns; game controllers 70 configured to run a slot game in the associated lower image display panel 141; a memory card 54 storing various symbol data for displaying a slot game on the lower image display panel 141; a graphic board 130 and a game controller 70 (graphic controller) configured to extract the various symbol data from the memory card 54 to generate display data, so as to display on the lower image display panel 141 display content determined by the game controller 70, wherein the game controller 70, through a control processes of (A) to (E), notifies a rank determination game to the graphic board 130, when the rank of the prize is randomly determined in advance by the external controller 621 (second controller) and that rank of the prize determined is received for generating display effect trigger for indicating the rank of the prize.

(A) a stage of displaying an indication of the rank of prize by associating it with one or more columns.

(B) a stage of displaying scroll of symbols to rearrange symbols, using all the five reels displaying only the flower symbols 502.

(C) a stage in which, if one or more flower symbol 502 as a specific symbol is displayed in the symbol matrix as the result of the rearrangement, a subsequent symbol scroll is executed while maintaining the specific symbol.

(D) a stage of executing the steps of (B) and (C) a predetermined number of times (for eight plays of free game).

(E) a stage of, when running the free game the predetermined number of times results in a display state in which the flower symbol 502 is displayed in all the rows of any of the five columns continuously from one side of the symbol matrix (Reel1 side on the left end) to the other side (Reel5 side), awarding the prize of the rank corresponding to the columns with the flower symbols 502 displayed on all the rows of the columns.

In the present example, the random determination of the jackpot and the random determination of the rank of the jackpot are executed in every unit game of each slot machine 10, by a link progressive generator 621B of the external controller 621 shown in FIG. 3. When the jackpot occurs in any of the slot machines 10 connected via the communication line 301 as the result of the random determination of the jackpot, the external controller 621 transmits winning of the jackpot and the rank data of the jackpot to the game controller 70 of the jackpot winning slot machine 10 to have the rank determination game executed.

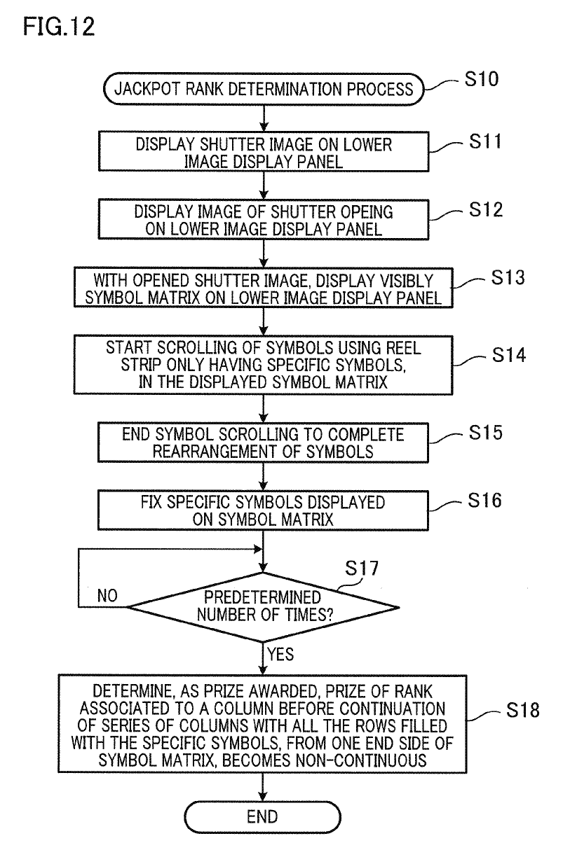

Once again, the following describes a flow of a game display screen generating process control for the determination of the rank, based on the flowchart indicative of the jackpot rank determination process shown in FIG. 12, referring to the display screens displayed on the upper image display panel 131 and the lower image display panel 141.

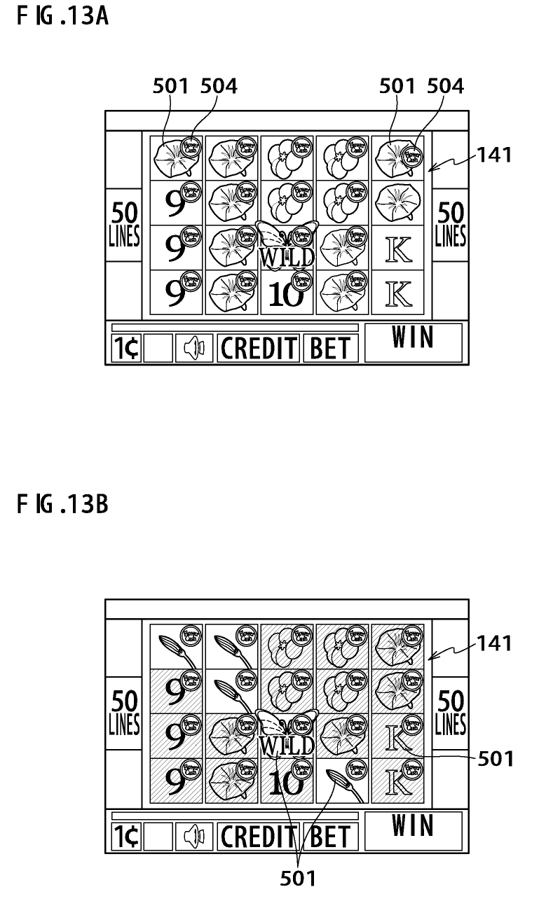

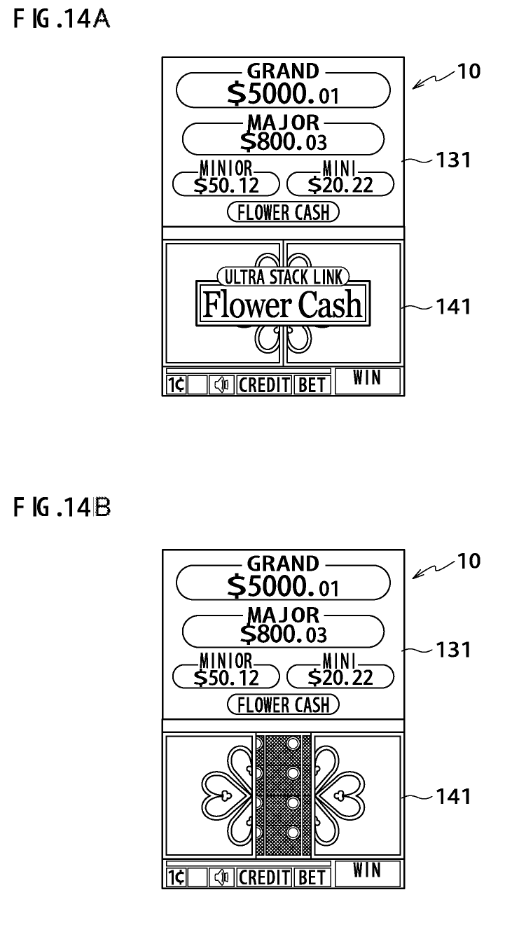

The slot machine 10 having received the winning of the jackpot and the jackpot rank data transmitted from the external controller 621 executes the display as shown in FIG. 13 and FIGS. 14A and 14B, and starts the jackpot rank determination process (S10). FIG. 13 shows a transition of the display state on the lower image display panel 141 which takes place from the base game G1 to occurrence of a trigger causing transition to a jackpot game G2. FIG. 13A shows a state immediately before the display state where a JP coin symbol 504 triggers a jackpot game, the JP coin symbol being a jackpot symbol which is a type of specific symbols. The display state transit from FIG. 13A to FIG. 13B, and changes to the state of triggering the jackpot game. The display state of triggering the jackpot game is a state in which the JP coin symbol 504 is rearranged in every place of the symbol matrix, in the present embodiment.

After the display state of triggering the jackpot game occurs as shown in FIG. 13B, the symbol matrix is temporarily masked as shown in FIG. 14A, to prepare the screen for starting the jackpot rank determination game (S11). As shown in FIG. 14B, a symbol matrix for running a next jackpot rank determination game appears through a gate-opening effect (S12). Next, when the gate opens, the five reels on the lower image display panel 141 are all changed to reels with only the flower symbols 502 (S13).

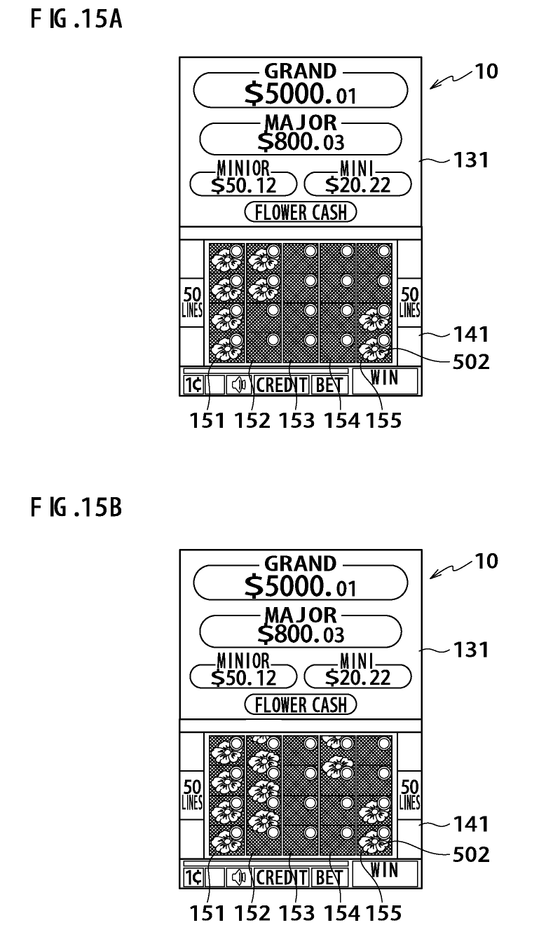

Then, under the control by the game controller 70, a unit game is run which uses reels only having the flower symbols 502 which serve as the specific symbols (S14). Although the free game using the reels only having the flower symbols 502 is repeated eight times, the number of plays is not limited to this, and a retrigger may be involved as hereinabove described. FIG. 15A shows rearrangement of flower symbols 502 in the first play of the free game (S15). No jackpot is won in this state, as is obvious from FIG. 19.

Next, the second play of the free game is run. However, the flower symbols 502 displayed in the first play of the free game do not move, and are fixed so that the second play of the free game is run with these flower symbols 502 fixed (S16). With the flower symbols being fixed, the number of flower symbols 502 arranged in the symbol matrix increases as the free game is repeated, which may lead to winning of a higher rank of jackpot.

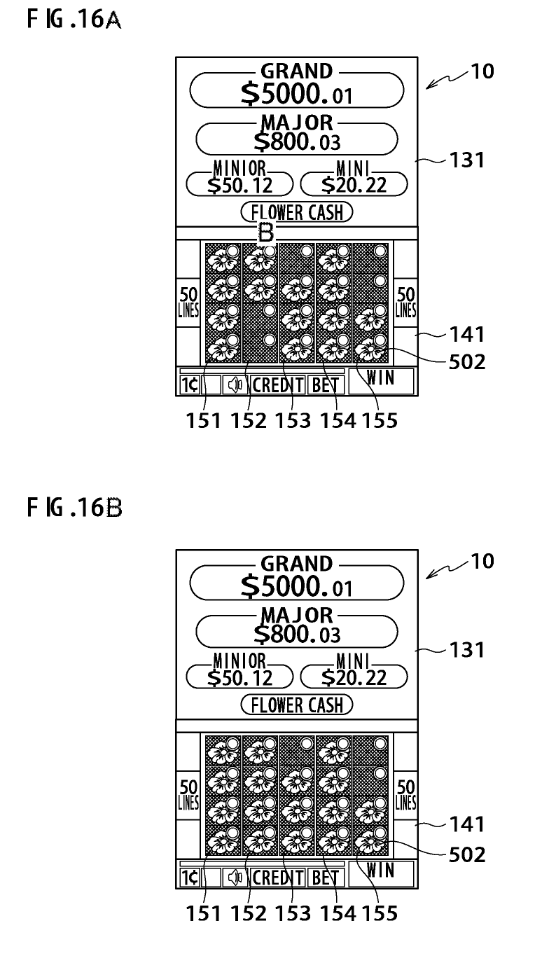

FIG. 15B shows rearrangement of flower symbols 502 in the second play of the free game. No jackpot win has not yet occurred in the second play of the free game too. FIG. 16A shows rearrangement of flower symbols 502 in the third play of the free game. No jackpot win has not yet occurred in the third play of the free game too. The flower symbol 502 is arranged in all the rows of line4 (reference numeral 154), however, the jackpot associated with the column is not won. This is because not every row of the line2 (reference numeral 154) and the line3 (reference numeral 154) has the flower symbol 502 arranged therein, as shown in FIG. 19C. In the present embodiment, the conditions for the prize occurrence include the columns with the flower symbol 502 arranged in every row being continuous from the left to right of the symbol matrix. Therefore, of the columns with the flower symbols 502 arranged in every row, which are continuous from one side (the side of the first stopped reel) to the other side, the game controller 70 notifies winning of the jackpot corresponding to the last column.

The game controller 70 determines whether or not the free game has been run eight times (S17). The determination of S17 may be followed by appearance of the character image A on the upper image display panel 131. The character image A usually does not appear, and the game controller 70 determines the prize of the rank associated with the last column out of a series of columns aligned side by side from the one side to the other side of the symbol matrix, each column having the flower symbol 502 serving as the specific symbol arranged in every row, the last column being the column before the continuation of the series of columns with the flower symbol 502 in every row ends (S18).

However, if the character image A appears on the upper image display panel 131 as hereinabove mentioned, after a time when the free game has been determined as to be run eight times (S17: YES) and before determining awarding of the prize of a rank in S18, the flower symbol 502 may be arranged in a position of the symbol matrix without the flower symbol 502 along with a motion of the character image A. When the character image A appears on the upper image display panel 131, awarding of the prize in S18 takes place after arrangement of the flower symbol 502 along with the motion of the character image A.

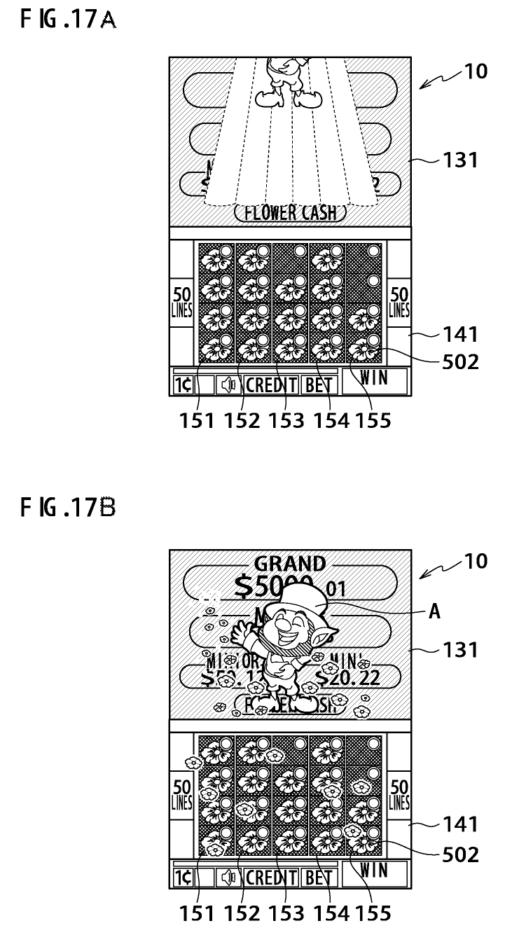

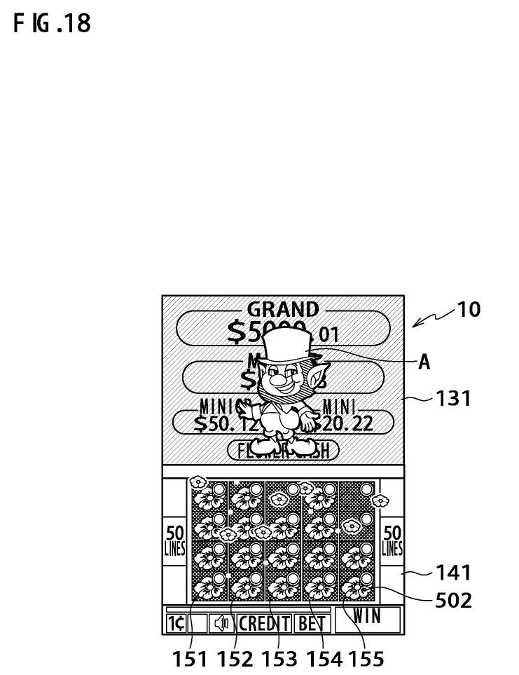

FIG. 17A shows a rearrangement of the flower symbols 502 in an eighth play (final play) of the free game, and appearance of the character image A on the upper image display panel 131. FIG. 17B shows a visual effect of the character image A changes the rearrangement of flower symbols 502 in the eighth play of the free game. The game controller 70 performs display control of a movie in which the character image A casting flower held in the character's hand, on the upper image display panel 131. In FIG. 18, a blank symbol is arranged in the symbol position of the first row in the column of reel3 (reference numeral 153) associated with MINOR. To this position, the flower casted by the character image A is arranged, changed into the flower symbol 502. Such a control of movie is executed by the game controller 70. In the control, the game controller 70 refers to a look up table in which video data stored in advance is associated with data corresponding to the rank of the progressive jackpot prize received from the external controller 621 serving as the second controller.

Embodiments of the present invention thus described above solely serve as specific examples of the present invention, and are not to limit the scope of the present invention. The specific structures and the like are suitably modifiable. Further, the effects described in the embodiments of the present invention described in the above embodiment are no more than examples of preferable effects brought about by the present invention, and the effects of the present invention are not limited to those described hereinabove.

Further, the detailed description above is mainly focused on characteristics of the present invention to fore the sake of easier understanding. The present invention is not limited to the above embodiments, and is applicable to diversity of other embodiments. Further, the terms and phraseology used in the present specification are adopted solely to provide specific illustration of the present invention, and in no case should the scope of the present invention be limited by such terms and phraseology. Further, it will be obvious for those skilled in the art that the other structures, systems, methods or the like are possible, within the spirit of the present invention described in this specification. The description of claims therefore shall encompass structures equivalent to the present invention, unless otherwise such structures are regarded as to depart from the spirit and scope of the present invention. Further, the abstract is provided to allow, through a simple investigation, quick analysis of the technical features and essences of the present invention by an intellectual property office, a general public institution, or one skilled in the art who is not fully familiarized with patent and legal or professional terminology. It is therefore not an intention of the abstract to limit the scope of the present invention which shall be construed on the basis of the description of the claims. To fully understand the object and effects of the present invention, it is strongly encouraged to sufficiently refer to disclosures of documents already made available.

The detailed description of the present invention provided hereinabove includes a process executed on a computer. The above descriptions and expressions are provided to allow the one skilled in the art to most efficiently understand the present invention. A process performed in or by respective steps yielding one result or blocks with a predetermined processing function described in the present specification shall be understood as a process with no self-contradiction. Further, the electrical or magnetic signal is transmitted/received and written in the respective steps or blocks. It should be noted that such a signal is expressed in the form of bit, value, symbol, text, terms, number, or the like solely for the sake of convenience. Although the present specification occasionally personifies the processes carried out in the steps or blocks, these processes are essentially executed by various devices. Further, the other structures necessary for the steps or blocks are obvious from the above descriptions.

### REFERENCE SIGNS LIST

10. Slot machine
121. Display
130. Graphic Board
131 Upper Image Display Panel
141. Lower Image Display Panel
151. Reel1 (First Column)
152. Reel2 (Second Column)
153. Reel3 (Third Column)
154. Reel4 (Fourth Column)
155. Reel5 (Fifth Column)
151 to 155. Reels
156. First Row
157. Second Row
158. Third Row
159. Fourth Row
301. Communication Line
501. Symbol
502. Flower Symbol
503. Wild Symbol
504. JP Coin Symbol
505. Feature Symbol
621. External Controller

What is claimed is:

1. A gaming machine, comprising:
a display configured to display a symbol matrix of M rows and N columns;
a game controller configured to run a slot game involving the symbol matrix;
a storage device storing data of various symbols, for displaying the slot game on the display;
a graphic controller configured to extract the various sets of symbol data from the storage device, and generate display data, for a purpose of displaying on the display a set of display content determined by the game controller; and
wherein the game controller executes a rank determination game with respect to the graphic controller, when the game controller receives the rank of a prize randomly determined in advance by a second controller, leading to occurrence of a display effect trigger for indicating the rank of the prize, said rank determination game including:
(A) a stage of displaying an indication of the rank of prize by associating it with one or more columns;
(B) a stage of displaying scroll of symbols in all of the N columns;
(C) a stage in which, if one or more specific symbols are displayed in the symbol matrix as the result of the rearrangement, a subsequent symbol scroll is executed while maintaining the specific symbol.
(D) a stage of executing the steps of (B) and (C) a predetermined number of times;
(E) a stage of, when repeating of the series of stages the predetermined number of times results in a display state in which the specific symbol is displayed in all the rows of any of the N columns continuously from one side of the symbol matrix to the other side, awarding the prize of the rank corresponding to the columns with the specific symbols displayed on all the rows of the columns.

2. The gaming machine according to claim 1, wherein,
the controller is configured so that in the stage of (A), the ranks of the prizes associated to columns of the symbol matrix arranged side by side from the one side to the other side are indicated in such a manner that the rank of prize is increased towards the other side; and
in the stage of (B), a prize of the rank associated to a column at the end on the other side, out of successive columns of the symbol matrix arranged side by side from the one side to the other side with the specific symbols in all the rows, is awarded.

3. The gaming machine according to claim 1, wherein,
the stage of (E) further includes a stage of awarding a fixed payout which is set in advance, if the endmost column on the one side has the specific symbol in all its rows and there is no column with the specific symbol arranged in every row on the other side.

4. A slot machine, comprising:
a display on which control for rearranging symbols from the state of symbols stopped on each reel is executed a predetermined number of times to determine a rank out of the ranks of prizes;
a graphic controller configured to display a label of a prize nearby the reels, wherein each reel is associated with any of the plurality of ranks of the prizes;
a game controller, wherein, after the rearrangement of symbols, the symbols are brought into a hold state and if the symbol in the hold state occurs in all the symbol display areas of the reel, the game controller awards a prize of the rank stored in advance in association with the reel.
